(19) United States
(12) Patent Application Publication
(10) Pub. No.: US 2018/0230294 A1
(43) Pub. Date: Aug. 16, 2018

(54) ALKYLPHOSPINATE SALTS AS IMPACT MODIFIER FOR LASER PLATABLE MATERIALS AND THE PROCESS THEREBY

(71) Applicant: SABIC Global Technologies B.V., Bergen op Zoom (NL)

(72) Inventors: Yunan CHENG, Shanghai (CN); Shijie SONG, Shanghai (CN)

(21) Appl. No.: 15/752,929

(22) PCT Filed: Aug. 24, 2016
(86) PCT No.: PCT/IB2016/055053

§ 371 Date: Feb. 15, 2018

Related U.S. Application Data
(60) Provisional application No. 62/209,914, filed on Aug. 26, 2015.

(51) Int. Cl. C08K 5/5313; C08K 7/14; C08K 3/22; C08K 7/00; C08K 3/08; B29C 45/00; B29C 35/08; B29B 7/90

(52) U.S. Cl. CPC C08K 5/5313; C23C 18/1641; C08K 3/22; C08K 7/00; C08K 3/08; B29C 45/0001; B29C 45/0005; B29C 35/0805; B29B 7/90; C08K 2003/2248; C08K 2003/2251; C08K 2003/0812; C08K 2201/003; C08K 2201/005; B29C 2035/0838; C08K 7/14

(57) ABSTRACT

Disclosed herein are laser activatable compositions. One composition may comprise: about 35% to about 75% by weight of at least one polyamide resin, preferably a 9,T resin; about 0.1% to about 20% by weight of a laser direct structuring additive; the laser activatable additive being operative to plate the composition upon being activated by a laser; about 0.5% to 20% by weight of a phosphorus-containing additive, preferably an organo phosphinate salt; and about 10% to 50% by weight of a reinforcing fiber, preferably a glass fiber having a substantially circular cross-section, the substantially circular cross-section having a diameter of 10 microns or less; where all weight percents are based on the total weight of the composition. Further embodiments provide compositions further comprising one or more organic, metallic, or mineral fillers, pigments, or combinations thereof. Also disclosed are methods of preparing these compositions and articles produced therefrom.

### CROSS REFERENCE TO RELATED APPLICATIONS

This application claims the benefit of and priority to U.S. Patent Application No. 62/209,914, filed Aug. 26, 2015, which is hereby incorporated herein by reference in its entirety.

### TECHNICAL FIELD

This disclosure relates to methods of structurally reinforcing 9,T polyamide compositions as well as improving the flame retardancy, mechanical strength, and laser activatability of the same.

### BACKGROUND

Currently, in electronics, there is great interest in reinforced thermoplastic devices containing selectively deposited metal conductor patterns on the molded thermoplastic. Such components offer the advantages of lighter weight and the ability to manufacture complex designs. There are multiple approaches to realize selective metal pattern construction on organic surfaces, including various MID (Molded Interconnect Device) approaches with LDS (Laser Direct Structuring) technology.

Mechanical strength, including mechanical stiffness of materials to prevent warping, especially as panels continue to have thinner cross-sectional thicknesses, and acceptable flame retardancy of the material to reduce fire related hazards are all critical to the performance of such components. Other critical properties include water absorption, dimensional stability, chemical and hydrolytic resistance, abrasion resistance, and mechanical properties at elevated temperatures.

Polyamides are suitable thermoplastics for these applications, owing to their high flow, high modulus and strength features. Relative to other polymer systems, though, traditionally used polyamides have issues with each of these properties. Further, and contrary to expectations, once LDS additives are compounded in such material, the strength of materials drops. There is need for improved LDS systems which use polyamide resins.

### SUMMARY

The present disclosure pertains to thermoplastic compositions that provide excellent mechanical and processing performance, for example, superior high impact strength and good ductility, compared to prior art compositions, their methods of making, and articles derived therefrom. In particular, the compositions comprise polyamide, at least one laser structuring additive, at least one phosphorus-containing additive, at least one type of reinforcing fiber, and optional fillers. So-called 9,T polyamides, derived from terephthalic acid and nonanediamine, are of particular interest, because of their superior water absorption, dimensional stability, chemical and hydrolytic resistance, abrasion resistance, mechanical properties at elevated temperatures, and flow characteristics relative to other, traditionally used polyamides. Many of these improvements appear to derive from the increased aliphatic content of the nonanediamine moieties, but these same moieties appear to cause increased challenges with respect to flammability. The present invention addresses at least some of these concerns.

Certain embodiments of the present inventive compositions comprise: (a) about 35% to about 75% by weight of at least one polyamide resin, preferably a 9,T polyamide resin; (b) about 0.1% to about 20% by weight of a laser direct structuring additive, for example a copper chromium oxide spinel.; the laser activatable additive being operative to plate the composition upon being activated by a laser; (c) about 0.5% to 20% by weight of a phosphorus-containing additive that is a phosphazene, a bisphenol A bis(diphenyl phosphate) (BPADP) compound, an organopolyphosphate, a phosphinate salt, or a combination thereof, preferably an organic phosphinate salt, for example an aluminum diethyl phosphinate (such as EXOLIT™ OP aluminum diethyl phosphinate); and (d) about 10% to 50% by weight of a reinforcing fiber; where all weight percents are based on the total weight of the composition.

In certain embodiments, the reinforcing filler comprises glass fiber, preferably wherein: (a) at least a portion of the glass fiber comprises a flat glass fiber, provided that the total content of the flat glass fiber is less than 20%, 18%, 16%, 14%, or 12% by weight of the total composition; (b) at least a portion of the glass fiber comprises a glass fiber having a substantially circular cross-section, the substantially circular cross-section having a diameter of 10 microns or less, 9 microns or less, 8 microns or less, 7 microns or less, 6 microns or less, or 5 microns or less; and/or (c) the glass fiber comprises a mixture of flat glass fibers and glass fibers having a substantially circular cross-section, the substantially circular cross-section having a diameter of 10 microns or less, 9 microns or less, 8 microns or less, 7 microns or less, 6 microns or less, or 5 microns or less.

Especially attractive compositions comprise: (a) about 35 to about 45% by weight of at least one 9,T polyamide; (b) about 2 to about 4% by weight of a copper oxide spinel or a copper chromium oxide spinel; (c) about 1% to 20% by weight of an organic phosphinate salt, preferably an aluminum phosphinate salt, such as EXOLIT™ OP phosphinate salt; (d) about 25% to 35% by weight of glass fibers, wherein glass fibers are present as a mixture of flat glass fibers and glass fibers having a substantially circular cross-section, the total content of the flat glass fiber being less than about 18% of the total composition and the glass fibers having a substantially circular cross-section having a diameter of 8 microns or less; and (e) about 10-15% by weight of polyetherimide (e.g., ULTEM™ polyetherimide) filler; where all weight percents are based on the total weight of the composition.

Additional embodiments of the present invention include methods of making the inventive compositions and articles derived from the described compositions and methods.

### BRIEF DESCRIPTION OF THE DRAWINGS

The present application is further understood when read in conjunction with the appended drawings. For the purpose of illustrating the subject matter, exemplary embodiments of the subject matter are shown in these drawings; however, the presently disclosed subject matter is not limited to the specific methods, devices, and systems disclosed. In addition, the drawings are not necessarily drawn to scale. In the drawings:

FIG. 1 shows a spider chart of typical property comparison for several of the inventive compositions; Corresponding to Table 4 (Example 1).

FIGS. 2, 3, and 4 show data for the tensile strength (FIG. 2), tensile elongation (FIG. 3), and unnotched Izod (FIG. 4) as a function of OP loading dependency (Example 1).

FIGS. 5 to 7 show graphic representations of the data presented in Tables 5 to 7, respectively.

FIGS. 8 and 9 show graphic representations of the data presented in Table 8.

FIGS. 10-14 show graphic representations of the data presented in Tables 9 to 13, respectively.

### DETAILED DESCRIPTION

Disclosed herein are compositions directed to polyamides, generally, and 9,T polyamides, specifically, and the interplay between components that either improve their structural integrity, their flame retardancy properties, or a combination of both. The compositions comprise at least one polyamide, a laser direct structuring additive, a phosphorus-containing compound, glass fibers, and optionally organic and/or inorganic (including metallic) fillers. The compositions display an advantageous combination of properties that render them useful in applications which require for both data/signal transfer or identification and good flame retardancy, for example, automotive, healthcare, notebook personal computers, e-books, tablet personal computers, and the like.

Disclosed herein too are methods of making these compositions and articles prepared therefrom.

It is to be noted that all ranges detailed herein include the endpoints. Numerical values from different ranges are combinable. Unless otherwise specifically specified, where all composition percentages are weight percents based on the total weight of the composition.

The transition term “comprising” encompasses the transition terms “consisting of and “consisting essentially of” The term “consisting essentially of,” is recognized as limiting the scope of a claim to the specified materials or steps “and those that do not materially affect the basic and novel characteristic(s)” of the claimed invention. As used herein, where referring to compositions, the “basic and novel characteristics” refer to the ability of the compositions to exhibit flame retardance as having a probability of a first time pass of attaining V-0 as per UL-94 standards is greater than or equal to 90% for samples comprising the disclosed flame retardant composition having a thickness of 0.6 millimeter or greater and the ability to be laser activatable in a laser direct structuring application.

The term “and/or” includes both “and” as well as “or.” For example, “A and/or B” is interpreted to be A, B, or A and B.

Certain embodiments provide compositions comprising or consisting essentially of: (a) about 35% to about 75% by weight of at least one polyamide resin; (b) about 0.1% to about 20% by weight of a laser direct structuring additive; the laser activatable additive being operative to plate the composition upon being activated by a laser; (c) about 0.5% to 20% by weight of a phosphorus-containing additive that is a phosphazene, a bisphenol A bis(diphenyl phosphate) (BPADP) compound, an organopolyphosphate, a phosphinate salt, or a combination thereof; and (d) about 10% to 50% by weight of a reinforcing fiber.

The compositions of the present disclosure include a polyamide-based resin. Such resins are characterized by the presence of an amide group (—C(O)NH—). Polyamides can be prepared by a number of known processes, and polyamides are commercially available from a variety of sources. Polyamides may be derived from the polymerization of organic lactams having from 4 to 12 carbon atoms. In one aspect, the lactams are represented by the formula (19):

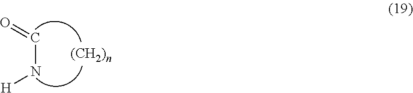

wherein n is 3 to 11. In one aspect, the lactam is epsilon-caprolactam having n equal to 5.

Polyamides can also be synthesized from amino acids having from 4 to 12 carbon atoms. In one aspect, the amino acids are represented by the formula (20):

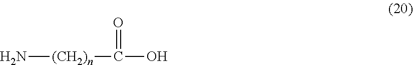

wherein n is 3 to 11. In one aspect, the amino acid is epsilon-aminocaproic acid with n equal to 5.

Polyamides can also be polymerized from aliphatic dicarboxylic acids having from 4 to 12 carbon atoms and aliphatic diamines having from 2 to 12 carbon atoms. In one aspect, the aliphatic diamines are represented by the Formula (21),

H₂N—(CH₂)ₙNH₂ (21)

wherein n is about 2 to about 12. In one aspect, the aliphatic diamine is hexamethylenediamine (H₂N(CH₂)₆NH₂). In one aspect, the molar ratio of the dicarboxylic acid to the diamine is from 0.66 to 1.5. Within this range it is generally beneficial to have the molar ratio be greater than or equal to 0.81. In another aspect, the molar ratio is greater than or equal to 0.96. In yet another aspect, the molar ratio is less than or equal to 1.22. In still another aspect, the molar ratio is less than or equal to 1.04. Examples of such hexamethylenediamine polyamides include, but are not limited to polyamide-6, polyamide-6,6, polyamide-4,6, polyamide-11, polyamide-12, polyamide-6,10, polyamide-6,12, polyamide 6/6,6, polyamide-6/6,12, polyamide MXD,6 (where MXD is m-xylylene diamine), polyamide-6,T, polyamide-6,I, polyamide-6/6,T, polyamide-6/6,I, polyamide-6,6/6,T, polyamide-6,6/6,I, polyamide-6/6,T/6,I, polyamide-6,6/6,T/6,I, polyamide-6/12/6,T, polyamide-6,6/12/6,T, polyamide-6/12/6,I, and polyamide-6,6/12/6,I.

Preferred polyamides include, but are not limited to, so-called 9,T polyamides, including such polyamides as prepared from the reaction between a dicarboxybenzene (e.g., terephthalic acid) and a nonanediamine. Such polyamides are available as GENESTAR™ polyamides available for Kuraray Co. Ltd., of Tokyo Japan. Available product information from Kuraray shows that such 9,T polyamides are superior to and distinguishable from other, more traditional hexamethylenediamine (“6,T”) polyamides. In particular, relative to unreinforced 6-T polyamides, the unreinforced 9,T polyamides (e.g., PA9T) reportedly exhibit: (i) superior water absorption (2.5%), for example about one-sixth that of PA46 (12%) and one-third that of PA6T (6.5%), when immersed in water at 23° C.; (ii) superior dimensional stability (0.1%), for example less than PA46 (ca. 0.8%), when subjected to 50% RH at 23° C.; (iii) superior chemical and hydrolytic resistance (72% retention of tensile strength), for example compared to PA6T (35% retention) when dipped in methanol at 23° C. for 7 days; (iv) superior abrasion resistance, showing a critical PV-value in excess of 800 kg/cm²-cm/sec vs. 525 kg/cm²-cm/sec for PA6T; and (v) superior mold flow characteristics, relative to the 6,T analogs (e.g., see Table 5).

Glass fiber reinforced composites show qualitatively similar improvements, relative to the 6,T derivatives. All of these properties offer the potential for improved molded products. But, as discovered herein, the use of 9,T polyamide products offers challenges with respect to flame retardancy, and typical strategies for improving this flame retardancy (e.g., incorporating certain additives) can come at the expense of physical character of the resin. Some of the improvements are reflected in the specific embodiments described herein.

In other embodiments, the compositions comprise polymers comprising chemical or physical mixtures of two or more of a polycarbonate, polyester, polyamide, or polyether.

In certain embodiments, the polyamide, or mixture or copolymer thereof, has flow properties useful for the manufacture of thin articles. Melt volume flow rate (often abbreviated MVR) measures the rate of extrusion of a thermoplastics through an orifice at a prescribed temperature and load. 9,T polyamides have flow properties that are especially attractive, and this represents one of their several more attractive features.

The polyamides, or mixtures or copolymers thereof, can have an intrinsic viscosity, as determined in chloroform at 25° C., of about 0.3 to about 1.5 deciliters per gram (dl/gm), specifically about 0.45 to about 1.0 dl/gm. The polyamides can have a weight average molecular weight of about 10,000 to about 200,000 Daltons, specifically about 20,000 to about 100,000 Daltons, as measured by gel permeation chromatography (GPC), using a crosslinked styrene-divinylbenzene column and calibrated to polycarbonate references. GPC samples are prepared at a concentration of about 1 mg per ml, and are eluted at a flow rate of about 1.5 ml per minute.

The polyamides, or mixtures or copolymers thereof may be present in an amount of about about 35% to about 75% by weight. In additional independent embodiments, the range may be from about 35% to about 40%, from about 40% to about 45%, from about 45% to about 50%, from about 50% to about 55%, from about 55% to about 60%, from about 60% to about 65%, from about 65% to about 70%, from about 70% to about 75%, or any combination of two or more of these ranges, based on the total weight of the composition.

Certain compositions, flame retardant or otherwise, comprise a so-called flame retarding agent. In some embodiments, the flame retarding agent comprises an organophosphorus compound, for example, a phosphazene, a bisphenol A bis(diphenyl phosphate) (BPADP) compound, an organopolyphosphate, a phosphinate salt, or a combination thereof, preferably an organic phosphinate salt, for example an aluminum diethyl phosphinate (such as EXOLIT™ OP phosphinate salt).

The composition comprises the phosphorus compound in an amount of about 0.5 to about 20 wt %, for example in a range of from 0.5% to less than 1%, from 1% to less than 2%, from 2% to less than 3%, from 3% to less than 4%, from 4% to less than 5%, from 5% to less than 6%, from 6% to less than 7%, from 7% to less than 8%, from 8% to less than 9%, from 9% to less than 10%, from 10% to less than 12%, from 12% to less than 14%, from 14% to less than 16%, from 16% to less than 18%, from 18% to 20%, or any combination of two or more of these ranges, based on the total weight of the composition.

The phosphazene compounds used in the compositions are defined as organic compounds having a —P═N— bond in the molecule. Exemplary phosphazenes useful in the present invention include cyclic phenoxyphosphazenes, chainlike phenoxyphosphazenes, and crosslinked phenoxyphosphazene compound. Such phosphazenes include phenoxyphosphazene, such as phenoxy cyclotriphosphazene, octaphenoxy cyclotetraphosphazene, decaphenoxy cyclopentaphosphazene, or a combination thereof.

However, the phosphorus-containing additive may also comprise an organophosphinate salt, such as aluminum diethyl phosphinate, for example EXOLIT™ OP phosphinate salt. As shown in Example 1, the addition of low levels of organophosphinate such as EXOLIT™ OP phosphinate salt show non-linear improvements in physical properties at low amounts (less than about 10 wt %, relative to the weight of the entire composition), with maximal improvements apparent at about 6-9 wt %. This non-linear behavior was completely unexpected and, to this point, unexplained.

In certain specific embodiments, the phosphinate salt, preferably EXOLIT™ OP phosphinate salt is present either: (a) from about 0.1% to less than 10% by weight; or (b) from about 10% about 20% by weight. In the lower level ranges, the compositions show remarkable improvements in structural performance, but the amount of EXOLIT™ OP phosphinate salt is insufficient to describe the total composition as flame retardant. In the upper level ranges, the amount of the EXOLIT™ OP phosphinate salt in the compositions is sufficient to describe the total composition as flame retardant. This distinction is made based on flammability responses to specific test criteria, for example as described in the Examples.

In various embodiments, the composition may contain reinforcing fillers. Examples of reinforcing fillers are glass fibers, carbon fibers, metal fibers, and the like. In certain independent embodiments, the reinforcing fiber may be present in a range of from 10% to 12%, from 12% to 14%, from 14% to 16%, from 16% to 18%, from 18% to 20%, from 20% to 22%, from 22% to 24%, from 24% to 26%, from 26% to 28%, from 28% to 30%, from 30% to 32%, from 32% to 34%, from 34% to 36%, from 36% to 38%, from 38% to 40%, from 40% to 42%, from 42% to 44%, from 44% to 46%, from 46% to 48%, from 48% to 50%, or any combination of two or more of these ranges.

The fibers may be carbon fibers comprising either carbon nanotubes or carbon fibers derived from pitch or polyacrylonitrile. The carbon nanotubes can be single wall carbon nanotubes or multiwall carbon nanotubes. The carbon nanotubes can have diameters of about 2.7 nanometers to about 100 nanometers and can have aspect ratios of about 5 to about 100. The aspect ratio is defined as the ratio of the length to the diameter.

The metal fibers can be whiskers (having diameters of less than 100 nanometers) or can have diameters in the micrometer regime. Metal fibers in the micrometer regime can have diameters of about 3 to about 30 micrometers. Exemplary metal fibers comprise stainless steel, aluminum, iron, nickel, copper, or the like, or a combination comprising at least one of the foregoing metals.

In preferred embodiments, the fibers are glass fibers. The glass fibers may be flat or round fibers. So-called flat glass fibers have an elliptical cross-sectional area, and are available from, for example, Nittobo. So-called round fibers have a circular cross-sectional area, where the cross-sectional areas are measured perpendicular to the longitudinal axis of the fiber. The term “substantially circular cross-section” refers to a fiber having a nominally circular cross-section, but where the circularity varies by manufacturing tolerances. The glass fibers may be manufactured from “E-glass,” “A-glass,” “C-glass,” “D-glass,” “R-glass,” “S-glass,” as well as E-glass derivatives that are fluorine-free and/or boron-free. The glass fibers may be woven or non-woven. The glass fibers can have a diameter of about 3 micrometers to about 25 micrometers, specifically about 4 micrometers to about 20 micrometers, and more specifically about 8 micrometers to about 15 micrometers. In some embodiments, the glass fibers may comprise one or more “sizing” agents or surface modifiers, which allow the glass fibers to better anchor in the polymer resin, thus allowing for transfer of shear loads from the glass fibers to the thermoset plastic. Such sizing agents or surface modifiers are known to comprise epoxy-based compounds, isocyanate-base compounds, silane-base compounds, and titanate-base compounds, and any one of more may be independently employed here. In other embodiments, the glass fibers are free of such sizing agents and/or surface modifiers.

The length of the glass fibers may be selected based on a desired balance of the mechanical characteristics and deformation of the molded article. Exemplary lengths include those in a range from about 25 to 50 microns, from 50 to 100 microns, from 100 to 250 microns, from 250 to 500 microns, from 500 to 1000 microns, from 1000 to 1500 microns, from 1500 to 2000 microns, or any combination of two or more of these ranges.

It has been shown by others that the use of flat glass fibers is preferred in polyamide systems, to the extent that circular cross-sectioned fibers do not provide sufficient flame retardancy or structural integrity, even for traditional 6,T polyamides. See, for example, U.S. Pat. No. 8,053,500 to Mitsubishi, which shows the inadequacy of glass fibers having a circular cross-section even in hexadiamine-containing polyamides. This Mitsubishi patent describes the need to include 20 to 65% by weight of glass fibers having a non-circular cross-section (flat glass) to achieve adequate performance. As discussed above, the use of 9,T polyamides, for all of its other benefits, only exacerbates the issues of flame retardancy. However, and contrary to this previous teaching, after extensive investigations, the present inventors have discovered that the presence of small-diameter glass fibers can be used to provide flame retardant systems without compromising the mechanical strength of the composite. That is, by substituting small diameter circular cross-sectioned glass fibers for all or some of the flat glass fibers, good performance can be realized even for the more difficult 9,T systems.

In certain embodiments, then, the reinforcing fibers of the inventive compositions comprise glass fibers in which the portion of the flat glass fiber, within the bounds described above, is independently less than 20%, 18%, 16%, 14%, 12%, 10%, or less than 8% by weight of the total composition. The balance of the reinforcing glass fibers (e.g., 2% to 30% by weight of the total composition) may then be glass fibers having a substantially circular cross-section, the substantially circular cross-section having a diameter of 10 microns or less, 9 microns or less, 8 microns or less, 7 microns or less, 6 microns or less, or 5 microns or less (to about 1, 2, 3, 4, or 5 microns).

In some cases, it is useful that the composition also comprise organic polymer fillers. Such fillers may serve as flame retardant synergists. These fillers may be present in an amount ranging from 1% to 4%, from 4% to 8%, from 8% to 12%, from 12% to 16%, from 16% to 20%, or any combination of two or more of these ranges, based on the weight of the total composition. These organic fillers preferably have flammability characteristic better than the 9,T polyamide. Polyetherimide (ULTEM™ polyetherimide), polycarbonates, and polyarylene oxides are especially suitable for this purpose.

The composition may also further comprise at least one inorganic, mineral, or metallic filler. These inorganic, mineral, or metallic fillers act synergistically to improve the flameout characteristics of the composites. For example, in those embodiments where the inorganic, mineral, or metallic filler comprises aluminum flakes, powders, or needles, an amount in range of only from about 0.1 to 2 weight percent based on the total weight of the composition was sufficient to provide measurable improvements in flame retardancy.

The composition may also comprise other mineral fillers. These mineral fillers also serve as flame retardant synergists, which improve the flame retardant properties when added to the composition over a comparative composition that contains all of the same ingredients in the same quantities except for the synergist. Examples of mineral fillers are mica, talc, calcium carbonate, dolomite, wollastonite, barium sulfate, silica, kaolin, feldspar, barytes, or the like, or a combination comprising at least one of the foregoing mineral fillers. The mineral filler may have an average particle size of about 0.1 to about 20 micrometers, specifically about 0.5 to about 10 micrometers, and more specifically about 1 to about 3 micrometers.

The mineral filler may be present in amounts of about 0.1 to about 20 wt %, specifically about 0.5 to about 15 wt %, and more specifically about 1 to about 5 wt %, based on the total weight of the composition. An exemplary mineral filler is talc.

In addition to the thermoplastic resin, the compositions of the present invention also include a laser direct structuring (LDS) additive. The LDS additive is selected to enable the composition to be used in a laser direct structuring process. The LDS additive is selected such that, upon exposed to a laser beam, metal atoms are activated and exposed and in areas not exposed by the laser beam, no metal atoms are exposed. In addition, the LDS additive is selected such that, after being exposed to laser beam, the etching area is capable of being plated to form conductive structure. As used herein “capable of being plated” refers to a material wherein a substantially uniform metal plating layer can be plated on a laser-etched area and show a wide window for laser parameters.

In addition to enabling the composition to be used in a laser direct structuring (LDS) process, the LDS additive used in the present invention is also selected to help increase the dielectric constant and lower the loss tangent by acting as a synergist with the ceramic filler. In general, high Dk, low Df compounds using ceramic fillers alone cannot be used to produce an antenna by using LDS technology. However, it has been found that the addition of an LDS additive, such as copper chromium oxide spinel, when added together with the ceramic fillers, the metal seeds can be formed by the LDS process and the conductor track structures can be arranged on these high Dk low Df materials by subsequent plating after activation by the laser during the LDS process. Breaking down copper chromium oxide spinel forms heavy-metal nuclei during activation with the laser during the LDS process. These nuclei enable the material to then be plated by enabling adhesion of the metallization layer in a metallization process. As such, the resulting materials have a low loss tangent. In one embodiment, the material has a loss tangent of 0.01 or less.

In addition, it has been found that the LDS additive provides a synergistic effect on the dielectric constant of the material. If no LDS additive is used, then, with ceramic fillers alone, in order to get certain level of dielectric constant, a high ceramic filler loading is necessary. As a result, the specific gravity of the materials is higher. However, by adding the LDS additive, it is possible to achieve the same level of dielectric constant using a small amount of LDS additive with a reduced ceramic filler loading. As a result, lower total filler loadings can be achieved as well as a lower specific gravity. As such, the weight of molded parts will be reduced, resulting in lighter, less expensive products.

Examples of LDS additives useful in the present invention include, but are not limited to, copper chromium oxide spinel, copper hydroxide phosphate, a copper phosphate, a copper sulfate, a cuprous thiocyanate, a spinel based metal oxide, a copper chromium oxide, palladium/palladium-containing heavy metal complexes, metal oxide, metal oxide-coated filler, antimony doped tin oxide coated on mica, copper containing metal oxides, zinc containing metal oxides, tin containing metal oxides, magnesium containing metal oxides, aluminum containing metal oxides, gold containing metal oxides, silver containing metal oxide, or a combination thereof. Copper chromium oxide spinels are preferred.

In some embodiments, the laser direct structuring additive is present in a range of from about 0.1% to about 20% by weight of a laser direct structuring additive; the laser activatable additive being operative to plate the composition upon being activated by a laser. In certain sub-embodiments, the LDS additive is present in an amount in a range of from 0.1% to 1%, from 1% to 2%, from 2% to 3%, from 3% to 4%, from 4% to 5%, from 5% to 6%, from 6% to 7%, from 7% to 8%, from 8% to 9%, from 9% to 10%, from 10% to 15%, from 15% to 20%, or any combination of two or more of these ranges, by weight relative to the total composition.

As discussed, the LDS additive is selected such that, after activating with a laser, the conductive path can be formed by following a standard electroless plating process. When the LDS additive is exposed to the laser, elemental metal is released. The laser draws the circuit pattern onto the part and leaves behind a roughened surface containing embedded metal particles. These particles act as nuclei for the crystal growth during a subsequent electroless plating process, such as an electroless copper plating process. Other electroless plating processes that may be used include, but are not limited to, gold plating, nickel plating, silver plating, zinc plating, tin plating or the like.

The composition may also further comprise 1 to 15 wt % of an organic or inorganic pigment. U.S. Patent Application No. US 2014/0353543, which is incorporated by reference herein, describes pigments useful in the present compositions.

The composition may further comprise a polysiloxane-polyamide copolymer as an impact modifier. The polydiorganosiloxane (also referred to herein as “polysiloxane”) blocks of the copolymer comprise repeating diorganosiloxane units as in formulae (22), (23), or (24):

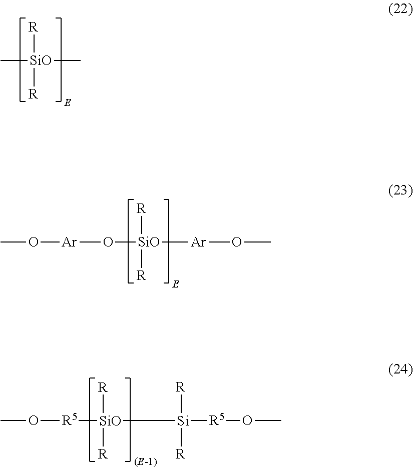

wherein each R is independently a C₁₋₁₃ monovalent organic group and Ar is an aromatic group. For example, R can be a C₁-C₁₃ alkyl, C₁-C₁₃ alkoxy, C₂-C₁₃ alkenyl group, C₂-C₁₃ alkenyloxy, C₃-C₆ cycloalkyl, C₃-C₆ cycloalkoxy, C₆-C₁₄ aryl, C₆-Cᵢ₀ aryloxy, C₇-C₁₃ arylalkyl, C₇-C₁₃ aralkoxy, C₇-C₁₃ alkylaryl, or C₇-C₁₃ alkylaryloxy. The foregoing groups can be fully or partially halogenated with fluorine, chlorine, bromine, or iodine, or a combination thereof. Combinations of the foregoing R groups can be used in the same copolymer. Ar groups in formula (23) can be derived from a C₆-C₃₀ dihydroxyarylene compound, for example a dihydroxyarylene compound.

The value of E in formula (22) can vary in value from about 2 to about 1,000, specifically about 2 to about 500, more specifically about 5 to about 100.

Specific polydiorganosiloxane blocks are of the formulae:

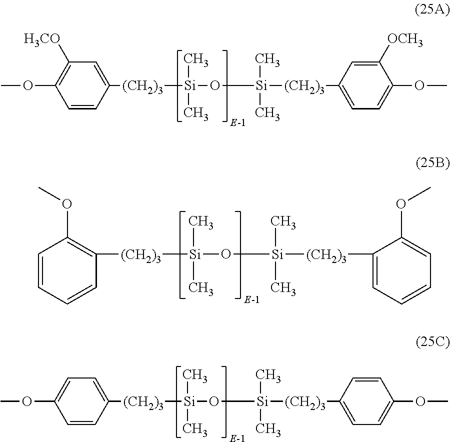

or a combination comprising at least one of the foregoing, wherein E has an average value of 2 to 200, 2 to 125, 5 to 125, 5 to 100, 5 to 50, 20 to 80, or 5 to 20.

The polyorganosiloxane-copolymers can comprise 1 to 50 weight percent siloxane units. Within this range, the polyorganosiloxane--copolymer can comprise 2 to 30 weight percent, more specifically 3 to 25 weight percent siloxane units. In an exemplary embodiment, the polyorganosiloxane- copolymer is endcapped with para-cumyl phenol.

Polyorganosiloxane-copolymers can have a weight average molecular weight of 2,000 to 100,000 Daltons, or 5,000 to 50,000 Daltons as measured by gel permeation chromatography using a crosslinked styrene-divinyl benzene column, at a sample concentration of 1 milligram per milliliter, and as calibrated with appropriate standards.

The disclosed polymer compositions can further optionally comprise one or more additives conventionally used in the manufacture of molded thermoplastic parts with the proviso that the optional additives do not adversely affect the desired properties of the resulting composition. Mixtures of optional additives can also be used. Such additives can be mixed at a suitable time during the mixing of the components for forming the composite mixture. For example, the disclosed compositions can comprise one or more lubricants, plasticizers, ultraviolet light absorbing additives, anti-dripping agents, dyes, flow modifiers, impact modifiers, stabilizers, anti-static agents, colorants, antioxidant, and/or mold release agents. In one aspect, the composition further comprises one or more optional additives selected from an antioxidant, flame retardant, and stabilizer. Suitable impact modifiers are typically high molecular weight elastomeric materials derived from olefins, monovinyl aromatic monomers, acrylic and methacrylic acids and their ester derivatives, as well as conjugated dienes.

As shown in the Examples, certain combinations of the prescribed ingredients provide for especially useful compositions, including those comprising: (a) about 35 to about 45% by weight of at least one 9,T polyamide resin; (b) about 2 to about 4% by weight of a laser direct structuring additive; the laser activatable comprising a copper oxide spinel or a copper chromium oxide spinel; (c) about 1% to 20% by weight of a phosphinate salt; and (d) about 25% to 35% by weight of glass fibers, wherein glass fibers are present as a mixture of flat glass fibers and glass fibers having a substantially circular cross-section, the total content of the flat glass fiber being less than 18% of the total composition and the glass fibers having a substantially circular cross-section having a diameter of 8 microns or less; where all weight percents are based on the total weight of the composition.

Other combinations of the prescribed ingredients which provide for especially useful compositions, include those comprising: (a) about 35 to about 45% by weight of at least one 9,T polyamide resin; (b) about 2 to about 4% by weight of a laser direct structuring additive; the laser activatable comprising a copper oxide spinel or a copper chromium oxide spinel; (c) about 10% to 20% by weight of an aluminum phosphinate salt, such as EXOLIT™ OP phosphinate salt; and (d) about 25% to 35% by weight of glass fibers, wherein glass fibers are present as a mixture of flat glass fibers and glass fibers having a substantially circular cross-section, the total content of the flat glass fiber being present in a range of from about 16 to 18% of the total composition and the glass fibers having a substantially circular cross-section having a diameter of 6 to 8 microns being present in a range of from about 8 to 17%; and about 10-15% by weight of polyetherimide (ULTEM™ polyetherimide) filler; where all weight percents are based on the total weight of the composition.

The compositions of the present may additionally be described in terms of their physical properties, when presented in conjunction with their physical compositions. In certain embodiments, the compositions presented may be further characterized by their exhibition of: (a) a flame out time (FOT) for a total of 5 bars of 40, 35, 30, 25, or 20 seconds or less at a sample thickness of at least 0.2 millimeters when tested per a UL-94 protocol; (b) a flexural modulus in a range of from 8500 to 9800 MPa when tested on a 32 mm sample, when tested at 1.27 mm/min as per ASTM D 790 at 23° C. (c) a tensile break strength in a range of from 110 to 150 MPa when tested at 5 mm/min as per ASTM D 638 at 23° C.; (d) a tensile elongation in a range of from 1.5 to 2.5% when tested at 5 mm/min as per ASTM D 256 at 23° C. (e) an unnotched Izod strength in a range of from 300 to 600 J/m when tested at 5 5 lb_{f}/ft as per ASTM D 256 at 23° C. or (f) a combination of two or more of (a), (b), (c), (d), or (e).

To this point, the invention has been described in terms of the compositions, but it should be appreciated that the scope of the present disclosure also includes the methods of making such compositions. For example, certain embodiments include those methods comprising: blending ingredients corresponding to any of the compositions described herein and extruding the composition. The blending process produces an intimate blend of ingredients. All of the ingredients can be added initially to the processing system, or else certain additives can be precompounded with one or more of the primary components.

In some embodiments, the composition is manufactured by blending the ingredients to be included in the final composition. The blending can be dry blending, melt blending, solution blending or a combination comprising at least one of the foregoing forms of blending. The composition can be dry blended to form a mixture in a device such as a Henschel mixer or a Waring blender prior to being fed to an extruder, where the mixture may be melt blended. In another embodiment, a portion of the polyamide can be premixed with the phosphorus-containing compound to form a dry preblend. The dry preblend is then melt blended with the remainder of the polyamide composition in an extruder. In one embodiment, some of the composition can be fed initially at the mouth of the extruder while the remaining portion of the composition is fed through a port downstream of the mouth.

Blending of the composition involves the use of shear force, extensional force, compressive force, ultrasonic energy, electromagnetic energy, thermal energy or combinations comprising at least one of the foregoing forces or forms of energy and is conducted in processing equipment wherein the aforementioned forces are exerted by a single screw, multiple screws, intermeshing co-rotating or counter rotating screws, non-intermeshing co-rotating or counter rotating screws, reciprocating screws, screws with pins, barrels with pins, rolls, rams, helical rotors, or combinations comprising at least one of the foregoing.

Where used, the compositions can be introduced into the melt blending device in the form of a masterbatch. In such a process, the masterbatch may be introduced into the blending device downstream of the point where the remainder of the composition is introduced.

Once blended and extruded, the compositions may be subject to molding conditions. The compositions can be converted to articles using common thermoplastic processes such as film and sheet extrusion, injection molding, gas-assisted injection molding, extrusion molding, compression molding and blow molding Exemplary processing conditions are provided in the Examples.

These compositions, including the molded compositions, may be further laser direct structured and optionally plated, preferably with copper.

The present invention further contemplates the articles manufactured any of the compositions, using any of the methods described herein, including those compositions having been laser direct structured and electrolessly plated, preferably with copper.

The following listing of Aspects in intended to complement, rather than displace or supersede, any of the previous descriptions.

Aspect 1. A composition comprising: (a) about 35% to about 75% by weight of at least one polyamide resin; (b) about 0.1% to about 20% by weight of a laser direct structuring additive; the laser activatable additive being operative to plate the composition upon being activated by a laser; (c) about 0.5% to 20% by weight of a phosphorus-containing additive that is a phosphazene, a bisphenol A bis(diphenyl phosphate) (BPADP) compound, an (d) organopolyphosphate, a phosphinate salt, or a combination thereof; and (e) about 10% to 50% by weight of a reinforcing fiber; where all weight percents are based on the total weight of the composition.

In separate of these Aspects, the composition comprises about 0.1% to less than 10% by weight of a phosphinate salt, preferably EXOLIT™ OP phosphinate salt. In these cases, the compositions show remarkable improvements in structural performance. In other Aspects, the composition comprises about 10% about 20% by weight of a phosphinate salt, preferably EXOLIT™ OP phosphinate salt. In these Aspects, the compositions exhibit flame retardancy.

Aspect 2. The composition of Aspect 1, where the polyamide resin comprises a linear polyamide, a branched polyamide, or a combination of a linear and a branched polyamide. In certain preferred sub-Embodiments, at least one of the polyamide resins or substantially all of the polyamide comprises a 9,T polyamide resin, the 9,T polyamide resin being derived from a dicarboxybenzene (e.g., terephthalic acid) and a nonanediamine.

Aspect 3. The composition of Aspect 1 or 2, where the polyamide resin comprises a blend of two polyamide homopolymers having different molecular weight than one another.

Aspect 4. The composition of any one of Aspect 1 to 3, where the polyamide has a weight average molecular weight of 15,000 to 40,000 Daltons.

Aspect 5. The composition of any one of Aspect 1 to 4, where the laser direct structuring additive is a copper chromium oxide spinel, copper hydroxide phosphate, a copper phosphate, a copper sulfate, a cuprous thiocyanate, a spinel based metal oxide, a copper chromium oxide, an organic metal complex, a palladium/palladium-containing heavy metal complex, a metal oxide, a metal oxide-coated filler, antimony doped tin oxide coated on mica, a copper containing metal oxide, a zinc containing metal oxide, a tin containing metal oxide, a magnesium containing metal oxide, an aluminum containing metal oxide, a gold containing metal oxide, a silver containing metal oxide, or a combination thereof, preferably comprising a copper chromium oxide spinel.

Aspect 6. The composition of any one of Aspects 1 to 5, where the laser direct structuring additive is present in a range of from about 1% to about 3, 4, 5, or 5% by weight relative to the total weight of the composition.

Aspect 7. The composition of any one of Aspects 1 to 6, where the laser direct structuring additive is a copper chromite spinel.

Aspect 8. The composition of any one of Aspects 1 to 7, wherein the phosphorus-containing additive is a phosphazene compound.

Aspect 9. The composition of any one of Aspects 1 to 7, wherein the phosphorus-containing additive is a phosphinate salt is aluminum diethyl phosphinate, for example EXOLIT™ OP phosphinate salt.

Aspect 10. The composition of any one of Aspects 1 to 8, wherein the phosphorus-containing additive is a phosphazene compound. In some sub-Embodiments, the phosphazene compound is a phenoxyphosphazene. In some of these Aspects, the phosphazene compound is phenoxy cyclotriphosphazene, octaphenoxy cyclotetraphosphazene, decaphenoxy cyclopentaphosphazene, or a combination thereof. In other sub-Embodiments, the phosphazene compound is a crosslinked phenoxyphosphazene.

Aspect 11. The composition of any one of Aspects 1 to 10, wherein the reinforcing filler comprises glass fiber.

Aspect 12. The composition of Aspect 11, where at least a portion of the glass fiber comprises a flat glass fiber, provided that the total content of the flat glass fiber is less than 20%, 18%, 16%, 14%, or 12% by weight of the total composition.

Aspect 13. The composition of Aspect 11 or 12, where a least a portion of the glass fiber comprises a glass fiber having a substantially circular cross-section, the substantially circular cross-section having a diameter of 10 microns or less, 9 microns or less, 8 microns or less, 7 microns or less, 6 microns or less, or 5 microns or less.

Aspect 14. The composition of any one of Aspect 11 to 13, where the glass fiber comprises a mixture of flat glass fibers and glass fibers having a substantially circular cross-section, the substantially circular cross-section having a diameter of 10 microns or less, 9 microns or less, 8 microns or less, 7 microns or less, 6 microns or less, or 5 microns or less.

Aspect 15. The composition of any one of Aspect 1 to 14, further comprising a flame retardant synergist in an amount of about 0.5 to about 10 weight percent based on the total weight of the composition; the flame retardant syngerist comprising a polymer or copolymer comprising polysiloxane blocks.

Aspect 16. The composition of any one of Aspects 1 to 15, further comprising an organic filler in an amount of 1 to 20 weight percent based on the total weight of the composition.

Aspect 17. The composition of Aspect 16, wherein the organic filler comprises polyetherimide (such as ULTEM™ polyetherimide).

Aspect 18. The composition of any one of Aspects 1 to 17, further comprising an inorganic, mineral, or metallic filler in an amount of 1 to 4 weight percent based on the total weight of the composition.

Aspect 19. The composition of Aspect 18, wherein the inorganic, mineral, or metallic filler comprises aluminum flakes or needles in an amount in a range of from about 0.1 to 2 weight percent based on the total weight of the composition

Aspect 20. The composition of Aspect 19, wherein the inorganic, mineral, or metallic filler is mica, talc, calcium carbonate, dolomite, wollastonite, barium sulfate, silica, kaolin, feldspar, or a combination comprising at least one of the foregoing mineral fillers.

Aspect 21. The composition of Aspect 20, wherein the inorganic, mineral, or metallic filler comprises talc having an average particle size of 1 to 3 micrometers.

Aspect 22. The composition of any one of Aspects 1 to 21, further comprising 1 to 15 wt % of a pigment.

Aspect 23. The composition of any one of Aspects 1 to 12, comprising: (a) about 35 to about 45% by weight of at least one 9,T polyamide resin; (b) about 2 to about 4% by weight of a laser direct structuring additive; the laser activatable comprising a copper oxide spinel or a copper chromium oxide spinel; (c) about 1% to 20% by weight of a phosphinate salt; (d) about 25% to 35% by weight of glass fibers, wherein glass fibers are present as a mixture of flat glass fibers and glass fibers having a substantially circular cross-section, the total content of the flat glass fiber being less than 18% of the total composition and the glass fibers having a substantially circular cross-section having a diameter of 8 microns or less; and (e) about 10-15% by weight of polyetherimide (e.g., ULTEM™ polyetherimide) filler; where all weight percents are based on the total weight of the composition.

Aspect 24. The composition of any one of Aspects 1 to 13 displaying: (a) a flame out time (FOT) for a total of 5 bars of 40, 35, 30, 25, or 20 seconds or less at a sample thickness of at least 0.2 millimeters when tested per a UL-94 protocol; (b) a flexural modulus in a range of from 8500 to 9800 MPa when tested on a 32 mm sample, when tested at 1.27 mm/min as per ASTM D 790 at 23° C.; (c) a tensile break strength in a range of from 110 to 150 MPa when tested at 5 mm/min as per ASTM D 638 at 23° C.; (d) a tensile elongation in a range of from 1.5 to 2.5% when tested at 5 mm/min as per ASTM D 256 at 23° C.; (e) an unnotched Izod strength in a range of from 300 to 600 J/m when tested at 5 5 lb_{f}/ft as per ASTM D 256 at 23° C. or (f) a combination of two or more of (a), (b), (c), (d), or (e).

Aspect 25. A method comprising: blending ingredients corresponding to the compositions of any one of Aspects 1 to 24; and extruding the composition.

Aspect 26. The method of Aspect 25, further comprising molding the composition.

Aspect27. The method of Aspect 25 or 26, further comprising laser direct structuring the molded composition.

Aspect 28. The method of Aspect 27, further comprising plating the laser structured molded composition.

Aspect 29. An article manufactured from the composition of any one of Aspects 1 to 24, the composition having been optionally laser direct structured.

Aspect 30. An article manufactured from the composition of Aspect 29, the composition having been laser direct structured and electrolessly plated, preferably with copper.

The following examples, which are meant to be exemplary, not limiting, illustrate the compositions and methods of manufacturing of some of the various embodiments of the compositions described herein. Each of the compositions described represents an individual embodiment of the invention, though the invention is not limited to these embodiments.

### EXAMPLE

### Example 1

### General Methods

Where so indicated, the compositions when prepared into test specimens having a thickness of at least 1.2 mm, exhibit a flammability class rating according to Underwriters Laboratories Inc. UL-94 of at least V-2, more specifically at least V-1, and yet more specifically at least V-0. In another embodiment, the compositions when prepared into specimens having a thickness of at least 2.0 millimeters, exhibit a flammability class rating according to Underwriters Laboratories Inc. UL-94 of at least V-2, more specifically at least V-1, and yet more specifically at least V-0.

Flammability tests were performed following the procedure of Underwriter's Laboratory Bulletin 94 entitled “Tests for Flammability of Plastic Materials, UL 94”. Several ratings can be applied based on the rate of burning, time to extinguish, ability to resist dripping, and whether or not drips are burning. The test conditions described in Bulletin 94 were adapted to the protocols described in U.S. patent application Ser. No. 13/901,388.

Where indicated, experiments directed to probability of first time pass, p(FTP), were measured according to the methods set forth in U.S. Pat. No. 6,308,142.

Izod Impact Strength is used to compare the impact resistances of plastic materials. Notched Izod impact strength was determined at both 23° C. and 0° C. using a 3.2-mm thick, molded, notched Izod impact bar. It was determined per ASTM D256. The results are reported in Joules per meter. Tests were conducted at room temperature (23° C.) and at a low temperature (−20° C.).

Heat deflection temperature (HDT) is a relative measure of a material's ability to perform for a short time at elevated temperatures while supporting a load. The test measures the effect of temperature on stiffness: a standard test specimen is given a defined surface stress and the temperature is raised at a uniform rate. HDT was determined as flatwise under 1.82 MPa loading with 3.2 mm thickness bar according to ASTM D648. Results are reported in ° C.

The compositions were all compounded from twin-screw extruder, and the pellets were collected for evaluation and molding. The ASTM standard molded parts were evaluated accordingly to the standards for flexural, tensile, notched Izod and multi axis impact. Operating conditions are provided in Table 1 and Table 2.

TABLE 1
Extrusion profile of polyamide

| Parameters | Unit | Polyamide |
|---|---|---|
| Compounder Type | NONE | TEM-37BS |
| Barrel Size | mm | 1500 |
| Die | mm | 3 |
| Feed (Zone 0) Temp | NONE | 50 |
| Zone 1 Temp | ° C. | 100 |
| Zone 2 Temp | ° C. | 150 |
| Zone 3 Temp | ° C. | 300-310 |
| Zone 4 Temp | ° C. | 300-310 |
| Zone 5 Temp | ° C. | 300-310 |
| Zone 6 Temp | ° C. | 295-305 |
| Zone 7 Temp | ° C. | 290-300 |
| Zone 8 Temp | ° C. | 285-295 |
| Zone 9 Temp | ° C. | 285-295 |
| Zone 10 Temp | ° C. | 285-295 |
| Zone 11 Temp | ° C. | 285-295 |
| Die Temp | ° C. | 285-295 |
| Screw speed | rpm | 300 |
| Throughput | kg/hr | 45 |
| Vacuum 1 | MPa | −0.08 |
| Side Feeder 1 speed | rpm | 300 |
| Melt temperature | NONE | 300 |

TABLE 2
Molding profile of polyamide

| Parameters | Unit | Polyamide |
|---|---|---|
| Cnd: Pre-drying time | Hour | 3 |
| Cnd: Pre-drying temp | ° C. | 110 |
| Molding Machine | NONE | FANUC |
| Mold Type (insert) | NONE | ASTM tensile, ASTM flexural, |
| | | ASTM Izod, Colorchip, UL bar |
| Hopper temp | ° C. | 50 |
| Zone 1 temp | ° C. | 290-300 |
| Zone 2 temp | ° C. | 295-305 |
| Zone 3 temp | ° C. | 300-310 |
| Nozzle temp | ° C. | 295-305 |
| Mold temp | ° C. | 100-150 |
| Screw speed | rpm | 100 |
| Back pressure | kgf/cm² | 30-50 |
| Cooling time | s | 15 |
| Injection speed | mm/s | 50-150 |
| Holding pressure | kgf/cm² | 600-800 |
| Max. Injection pressure | kgf/cm² | 1000-1200 |

### Example 2

### Polyamide Composites

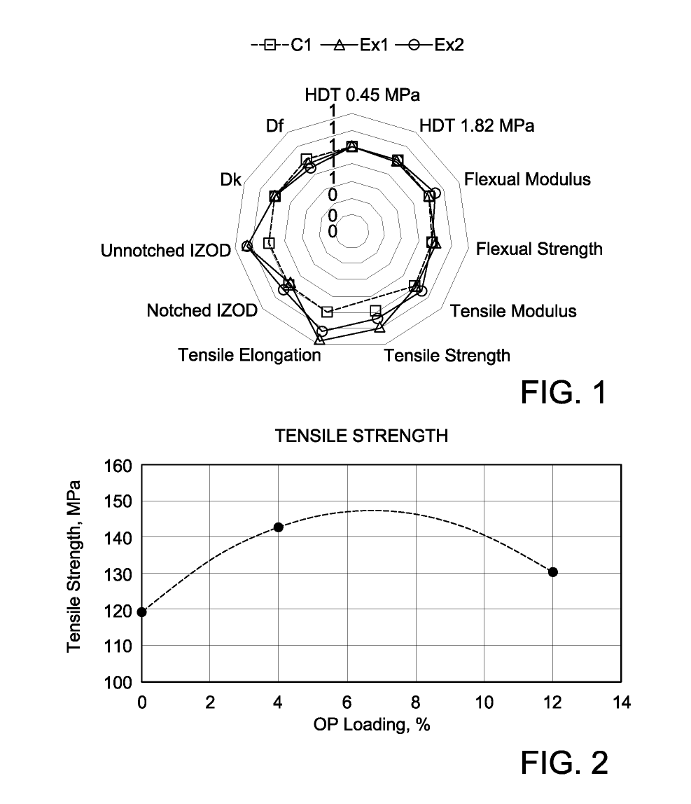

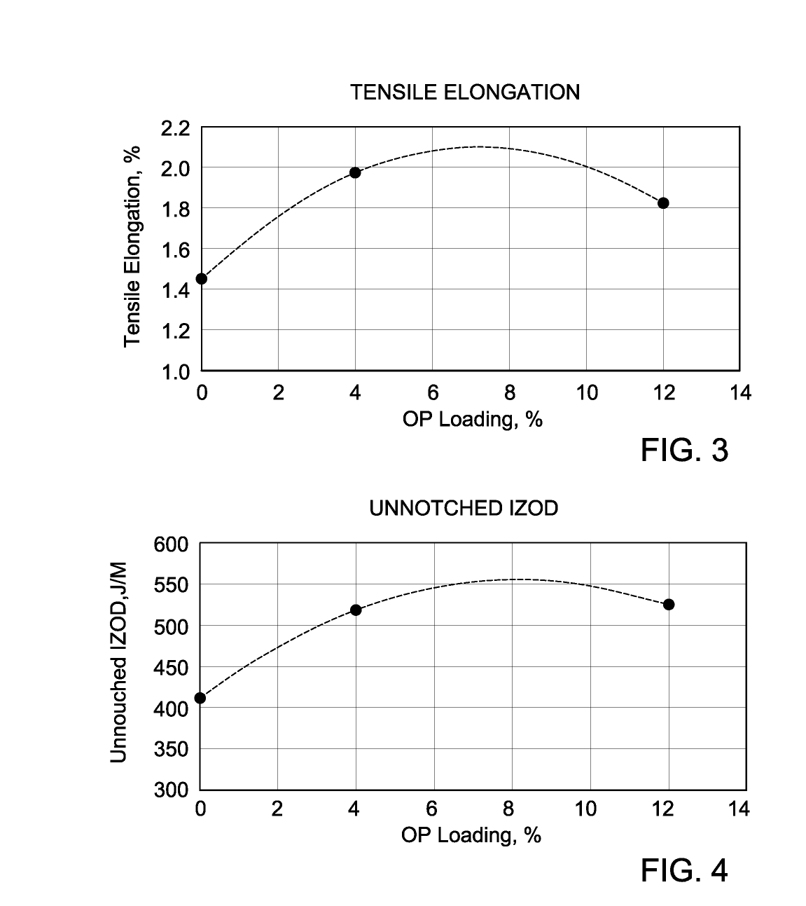

Example 2.1. Effect of Loading EXOLIT™ OP phosphinate salt and Thin Circular Glass Fiber on Strength and Ductility. Compositions were prepared according to the methods provided in Example 1. Tables 3 and 4 and FIGS. 1-4 show the effect of loading of EXOLIT™ OP phosphinate salt on physical parameters. FIG. 1 further compared the typical properties in the format of spider chart. FIGS. 2-4 quantify the tensile strength, tensile elongation and unnotched Izod dependency on OP loading. The data show that the addition of EXOLIT™ OP phosphinate salt increased strength and ductility (tensile strength, tensile elongation, unnotched Izod). Tensile strength continued to increase as OP loading increases, with saturation at around 6% EXOLIT™ OP phosphinate salt. With 7-8% and above EXOLIT™ OP phosphinate salt, the tensile strength tended to decrease but was still higher than compositions having no EXOLIT™ OP phosphinate salt. The same trends were observed for tensile elongation and unnotched Izod.

TABLE 3
Composition of listed the formulation with different loading
(0-12%) of EXOLIT ™ OP phosphinate salt.

| Item Code | Item Description | Unit | C1 | Ex1 | Ex2 |
|---|---|---|---|---|---|
| C835991 | Kurary PA9T GC48020 polyamide | % | 33.4 | 31.4 | 27.4 |
| C835503 | Kurary PA9T GC 51010 polyamide | % | 33.3 | 31.3 | 27.3 |
| F542 | PHOSPHITE STABILIZER | % | 0.15 | 0.15 | 0.15 |
| 25808 | Phenolic prim antioxidant for PA | % | 0.15 | 0.15 | 0.15 |
| F594827 | BLACK 30C965 Copper Chromite | % | 3 | 3 | 3 |
| | Black Spinel | | | | |
| 4027 | EXOLIT ™ OP phosphinate salt 1230 | % | | 4 | 12 |
| G513189 | Glass Fiber CPIC ECS-301HP (E)- | % | 30 | 30 | 30 |
| | 7.5 um/3 mm | | | | |

TABLE 4
Typical properties of polyamide composites with different loading of EXOLIT ™ OP salt.

| Typical | | | | | | |
|---|---|---|---|---|---|---|
| Property | Test Method | Test Description | Unit | C1 | Ex1 | Ex2 |
| Spiral flow | SABIC method | 310° C., 130° C., 1.0 mm | cm | 30 | 27 | 26 |
| Spiral flow | SABIC method | 310° C., 130° C., 0.75 mm | cm | 21 | 21 | 17 |
| HDT 0.45 MPa | ASTM D 648 | 0.45 MPa/3.2 mm | ° C. | 275 | 275 | 275 |
| HDT 1.82 MPa | ASTM D 790 | 1.82 MPa/3.2 mm | ° C. | 253 | 252 | 253 |
| Flexual Modulus | ASTM D 790 | 3.2 mm, 1.27 mm/min | MPa | 8750 | 8910 | 9560 |
| Flexual Strength | ASTM D 638 | yield, 3.2 mm, 1.27 mm/min | MPa | 182 | 184 | 176 |
| Tensile Modulus | ASTM D 638 | 5 mm/min | MPa | 9069 | 9212 | 10013 |
| Tensile Strength | ASTM D 638 | break, 5 mm/min | MPa | 120 | 143 | 130 |
| Tensile | ASTM D256 | break, 5 mm/min | % | 1.5 | 2.0 | 1.8 |
| Elongation | | | | | | |
| Notched Izod | ASTM D256 | 23° C., 2 lbf/ft | J/m | 36 | 34 | 38 |
| Unnotched Izod | ASTM D256 | 23° C., 5 lbf/ft | J/m | 412 | 518 | 524 |
| Dk | SABIC | 1.1 GHz | | 3.540 | 3.530 | 3.533 |
| Df | SABIC | 1.1 GHz | | 0.012 | 0.011 | 0.011 |
| Moisture | ISO 62 | 23° C., 24 hours | % | 0.05 | 0.05 | 0.04 |
| Moisture | ISO 62 | 23° C., 312 hours | % | 0.15 | 0.16 | 0.10 |
| Mold Shrinkage | SABIC method | Parallel | % | 0.3 | 0.3 | 0.3 |
| Mold Shrinkage | SABIC method | Perpendicular | % | 0.7 | 0.6 | 0.6 |

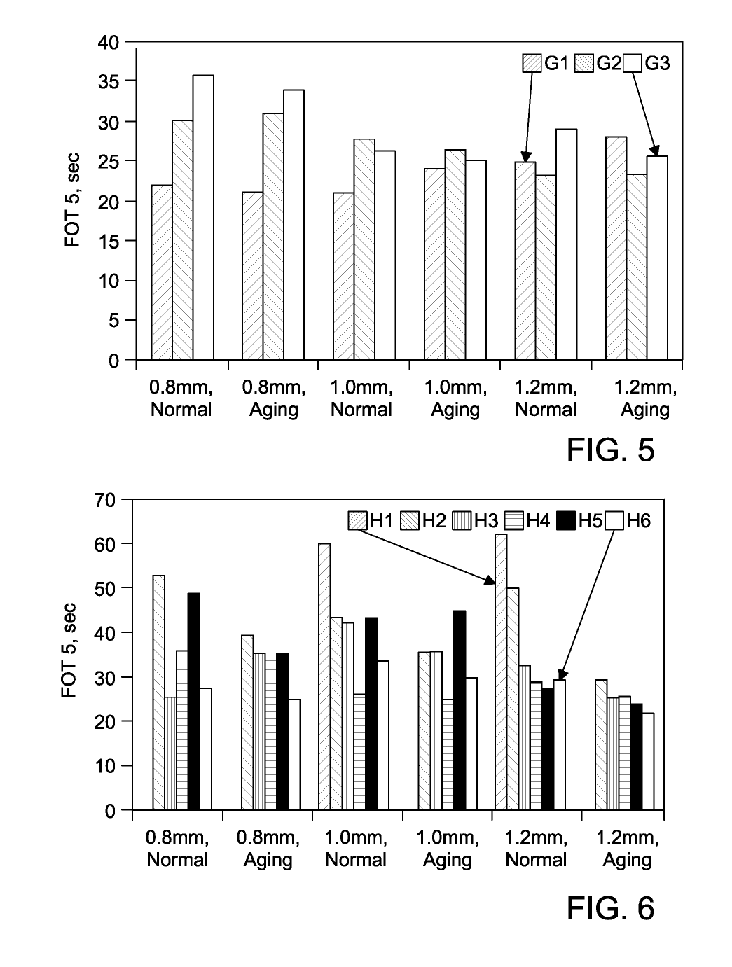

Example 2.2. Effect of Polyamide type: A series of experiments were done to compare the properties of compositions made with various polyamide types, holding other compositional parameters constant (i.e., 30% glass fiber, 12% EXOLIT™ OP phosphinate salt and 5% copper chromite oxide). The results are show in Table 5 and FIG. 5. Overall, 6T based high heat polyamide (G1) had shortest FOT at 0.8 mm and above thickness burning, but had worst flow ability and was not suitable for 0.4 mm and below bar burning test. Samples G2 and G3 (9T-based high heat polyamide) exhibited good flow and could achieve 0.4 mm and below bar molding. However, both G2 and G3 had longer FOT than G1. Additionally, G3 offered high temperature (HDT) but a dropping behavior at 0.4 mm and longest FOT at 0.8 mm and above. These results are also shown in FIG. 5.

TABLE 5
Performance of various polyamides with 30% glass fiber, 12% EXOLIT ™ OP
phosphinate salt and 5% copper chromite oxide with different type of high heat polyamide.

| Item Code | Item Description | | Unit | G1 | G2 | G3 |
|---|---|---|---|---|---|---|
| 125462 | AMODEL A 1006 | | % | 52.7 | | |
| C835991 | Kurary PA9T GC48020 | | % | | 52.7 | |
| C835503 | Kurary PA9T GC 51010 | | % | | | 52.7 |
| F542 | PHOSPHITE STABILIZER | | % | 0.15 | 0.15 | 0.15 |
| 25808 | Phenolic prim antioxidant | | % | 0.15 | 0.15 | 0.15 |
| | for PA | | | | | |
| F594827 | BLACK 30C965 | | % | 5 | 5 | 5 |
| 4027 | EXOLIT ™ OP 1230 | | % | 12 | 12 | 12 |
| | phosphinate salt | | | | | |
| G512950 | Nittobo (flat)glass fiber | | % | 30 | 30 | 30 |
| | CSG3PA820 | | | | | |
| Typical | | | | | | |
| Property | Test Method | Test Description | Unit | G1 | G2 | G3 |
| MVR | ASTM D 1238 | 310° C./1.2 kg/360 s | cm³/10 | 4 | 35 | 25 |
| | | | min | | | |
| Spiral flow | SABIC method | 310° C., 130° C., | cm | 1 | 28 | 23 |
| | | 1.0 mm | | | | |
| Spiral flow | SABIC method | 310° C., 130° C., | cm | 1 | 18 | 15 |
| | | 0.75 mm | | | | |
| HDT | ASTM D 648 | 0.45 MPa/3.2 mm | ° C. | >280 | 255 | >280 |
| HDT | ASTM D 648 | 1.82 MPa/3.2 mm | ° C. | 261 | 234 | 266 |
| Flexual | ASTM D 790 | 3.2 mm, | MPa | 10400 | 9380 | 8930 |
| Modulus | | 1.27 mm/min | | | | |
| Flexual | ASTM D 790 | yield, 3.2 mm, | MPa | 150 | 155 | 151 |
| Strength | | 1.27 mm/min | | | | |
| Tensile | ASTM D 638 | 5 mm/min | MPa | 10900 | 10018 | 9678 |
| Modulus | | | | | | |
| Tensile | ASTM D 638 | break, 5 mm/min | MPa | 100 | 111 | 100 |
| Strength | | | | | | |
| Tensile | ASTM D 638 | break, 5 mm/min | % | 1.5 | 1.6 | 1.5 |
| Elongation | | | | | | |
| Notched | ASTM D256 | 23° C., 2 lbf/ft | J/m | 33 | 43 | 40 |
| Izod | | | | | | |
| Unnotched | ASTM D256 | 23° C., 5 lbf/ft | J/m | 310 | 370 | 380 |
| Izod | | | | | | |
| Dielectric | | 1 GHz | | 3.648 | 3.607 | 3.607 |
| Constant | | | | | | |
| Dissipation | | 1 GHz | | 0.012 | 0.010 | 0.010 |
| Factor | | | | | | |
| Plating | | | | 1.00 | 1.00 | |
| Index | | | | | | |
| Drops | 0.4 mm, normal | | | cannot | 0 | 4 |
| p(FTP) V0 | 0.4 mm, normal | | | fill | 0.8 | 0.0 |
| FOT 5 | 0.4 mm, normal | | second | due to | 35 | 34 |
| Drops | 0.4 mm, aging | | | low | 0 | 7 |
| p(FTP) V0 | 0.4 mm, aging | | | flow | 0.9 | 0.0 |
| FOT 5 | 0.4 mm, aging | | second | | 34 | 35 |
| Drops | 0.8 mm, normal | | | 0 | 0 | 0 |
| p(FTP) V0 | 0.8 mm, normal | | | 1.0 | 1.0 | 0.9 |
| FOT 5 | 0.8 mm, normal | | second | 22 | 30 | 36 |
| Drops | 0.8 mm, aging | | | 0 | 0 | 0 |
| p(FTP) V0 | 0.8 mm, aging | | | 1.0 | 0.9 | 0.7 |
| FOT 5 | 0.8 mm, aging | | second | 21 | 31 | 34 |
| Drops | 1.0 mm, normal | | | 0 | 0 | 0 |
| p(FTP) V0 | 1.0 mm, normal | | | 1.0 | 1.0 | 1.0 |
| FOT 5 | 1.0 mm, normal | | second | 21 | 28 | 26 |
| Drops | 1.0 mm, aging | | | 0 | 0 | 0 |
| p(FTP) V0 | 1.0 mm, aging | | | 1.0 | 0.9 | 1.0 |
| FOT 5 | 1.0 mm, aging | | second | 24 | 27 | 25 |
| Drops | 1.2 mm, normal | | | 0 | 0 | 0 |
| p(FTP) V0 | 1.2 mm, normal | | | 1.0 | 1.0 | 1.0 |
| FOT 5 | 1.2 mm, normal | | second | 20 | 23 | 29 |
| Drops | 1.2 mm, aging | | | 0 | 0 | 0 |
| p(FTP) V0 | 1.2 mm, aging | | | 1.0 | 1.0 | 1.0 |
| FOT 5 | 1.2 mm, aging | | second | 20 | 23 | 26 |

Example 2.3. Effect of LDS Additive Type (Particle Size) and Concentration: A series of experiments were done to compare the properties of 9,T polyamide compositions made with various LDS additive types (particle sizes) and concentrations (0.5 wt % copper chromite oxide), holding other compositional parameters constant (i.e., 30% flat glass fiber and 12% EXOLIT™ OP phosphinate salt). The results are shown in Table 6 and FIG. 6. The average diameter of copper chromite oxide as used in H2, H3, H4 was greater than 1 μm, typically 1.3 μm. The average diameter of copper chromite oxide as used in H5, H6 was less than 1 μm, typically 600 nm. The FOTs are further compared in FIG. 6.

TABLE 6
Effect of copper chromite particle size on performance of polyamide composites with
30% glass fiber, 12% EXOLIT ™ OP phosphinate salt and 0-5% copper chromite oxide.

| Item Code | Item Description | | Unit | H1 | H2 | H3 | H4 | H5 | H6 |
|---|---|---|---|---|---|---|---|---|---|
| C835503 | Kurary PA9T | | % | 57.7 | 55.7 | 54.7 | 52.7 | 54.7 | 52.7 |
| | GC 51010 | | | | | | | | |
| | polyamide | | | | | | | | |
| F542 | PHOSPHITE | | % | 0.15 | 0.15 | 0.15 | 0.15 | 0.15 | 0.15 |
| | STABILIZER | | | | | | | | |
| 25808 | Phenolic prim | | % | 0.15 | 0.15 | 0.15 | 0.15 | 0.15 | 0.15 |
| | antioxidant for | | | | | | | | |
| | PA | | | | | | | | |
| F594825 | Shepherd | | % | 0 | 2 | 3 | 5 | | |
| | Black 1G | | | | | | | | |
| | chromite spinel | | | | | | | | |
| F594827 | BLACK | | % | | | | | 3 | 5 |
| | 30C965 | | | | | | | | |
| | chromite spinel | | | | | | | | |
| 4027 | EXOLIT ™ OP | | % | 12 | 12 | 12 | 12 | 12 | 12 |
| | 1230 | | | | | | | | |
| G512950 | Nittobo | | % | 30 | 30 | 30 | 30 | 30 | 30 |
| | (flat)glass fiber | | | | | | | | |
| | CSG3PA820 | | | | | | | | |
| Typical | | | | | | | | | |
| Property | Test Method | Test Description | Unit | H1 | H2 | H3 | H4 | H5 | H6 |
| MVR | ASTM D 1238 | 310° C./1.2 kg/360 s | cm³/10 | 28 | 28 | 26 | 25 | 29 | 28 |
| | | | min | | | | | | |
| Spiral flow | SABIC method | 310° C., 130° C., | cm | 26 | 24 | 24 | 23 | 26 | 24 |
| | | 1.0 mm | | | | | | | |
| Spiral flow | SABIC method | 310° C., 130° C., | cm | 16 | 15 | 15 | 15 | 17 | 13 |
| | | 0.75 mm | | | | | | | |
| HDT | ASTM D 648 | 0.45 MPa/3.2 mm | ° C. | >280 | >280 | >280 | >280 | >280 | >280 |
| HDT | ASTM D 648 | 1.82 MPa/3.2 mm | ° C. | 278 | 267 | 266 | 266 | 266 | 268 |
| Flexual | ASTM D 790 | 3.2 mm, | MPa | 9170 | 8460 | 8720 | 8930 | 9154 | 9030 |
| Modulus | | 1.27 mm/min | | | | | | | |
| Flexual | ASTM D 790 | yield, 3.2 mm, | MPa | 213 | 152 | 154 | 151 | 152 | 154 |
| Strength | | 1.27 mm/min | | | | | | | |
| Tensile | ASTM D 638 | 5 mm/min | MPa | 9785 | 9416 | 9454 | 9678 | 9627 | 9458 |
| Modulus | | | | | | | | | |
| Tensile | ASTM D 638 | break, 5 mm/min | MPa | 143 | 104 | 104 | 100 | 100 | 92 |
| Strength | | | | | | | | | |
| Tensile | ASTM D 638 | break, 5 mm/min | % | 2.1 | 1.6 | 1.5 | 1.5 | 1.4 | 1.3 |
| Elongation | | | | | | | | | |
| Notched | ASTM D256 | 23° C., 2 lbf/ft | J/m | 98 | 43 | 41 | 40 | 39 | 43 |
| Izod | | | | | | | | | |
| Unnotched | ASTM D256 | 23° C., 5 lbf/ft | J/m | 747 | 377 | 379 | 380 | 323 | 323 |
| Izod | | | | | | | | | |
| Dielectric | | 1 GHz | | 3.510 | 3.527 | 3.547 | 3.607 | | |
| Constant | | | | | | | | | |
| Dissipation | | 1 GHz | | 0.010 | 0.010 | 0.010 | 0.010 | | |
| Factor | | | | | | | | | |
| Moisture | ISO 62 | 23° C., 24 hours | % | | | | | | |
| Moisture | ISO 62 | 23° C., 312 hours | % | | | | | | |
| Plating | | | | | | | | | |
| Index | | | | | | | | | |
| Drops | 0.8 mm, normal | | | 1 | 0 | 0 | 0 | 0 | 0 |
| p(FTP) V0 | 0.8 mm, normal | | | 0.0 | 0.1 | 1.0 | 0.9 | 0.4 | 1.0 |
| FOT 5 | 0.8 mm, normal | | second | 63 | 53 | 25 | 36 | 49 | 27 |
| Drops | 0.8 mm, aging | | | | 0 | 0 | 0 | 0 | 0 |
| p(FTP) V0 | 0.8 mm, aging | | | | 0.6 | 0.9 | 0.7 | 1.0 | 1.0 |
| FOT 5 | 0.8 mm, aging | | second | | 39 | 35 | 34 | 35 | 25 |
| Drops | 1.0 mm, normal | | | 0 | 0 | 0 | 0 | 0 | 0 |
| p(FTP) V0 | 1.0 mm, normal | | | 0.0 | 0.6 | 0.5 | 1.0 | 0.4 | 0.8 |
| FOT 5 | 1.0 mm, normal | | second | 60 | 43 | 42 | 26 | 43 | 34 |
| Drops | 1.0 mm, aging | | | | 0 | 0 | 0 | 0 | 0 |
| p(FTP) V0 | 1.0 mm, aging | | | | 0.8 | 0.9 | 1.0 | 0.4 | 1.0 |
| FOT 5 | 1.0 mm, aging | | second | | 36 | 36 | 25 | 45 | 30 |
| Drops | 1.2 mm, normal | | | 0 | 0 | 0 | 0 | 0 | 0 |
| p(FTP) V0 | 1.2 mm, normal | | | 0.0 | 0.2 | 0.9 | 1.0 | 0.9 | 1.0 |
| FOT 5 | 1.2 mm, normal | | second | 62 | 50 | 33 | 29 | 27 | 29 |
| Drops | 1.2 mm, aging | | | | 0 | 0 | 0 | 0 | 0 |
| p(FTP) V0 | 1.2 mm, aging | | | | 1.0 | 1.0 | 1.0 | 1.0 | 1.0 |
| FOT 5 | 1.2 mm, aging | | second | | 29 | 25 | 26 | 24 | 22 |

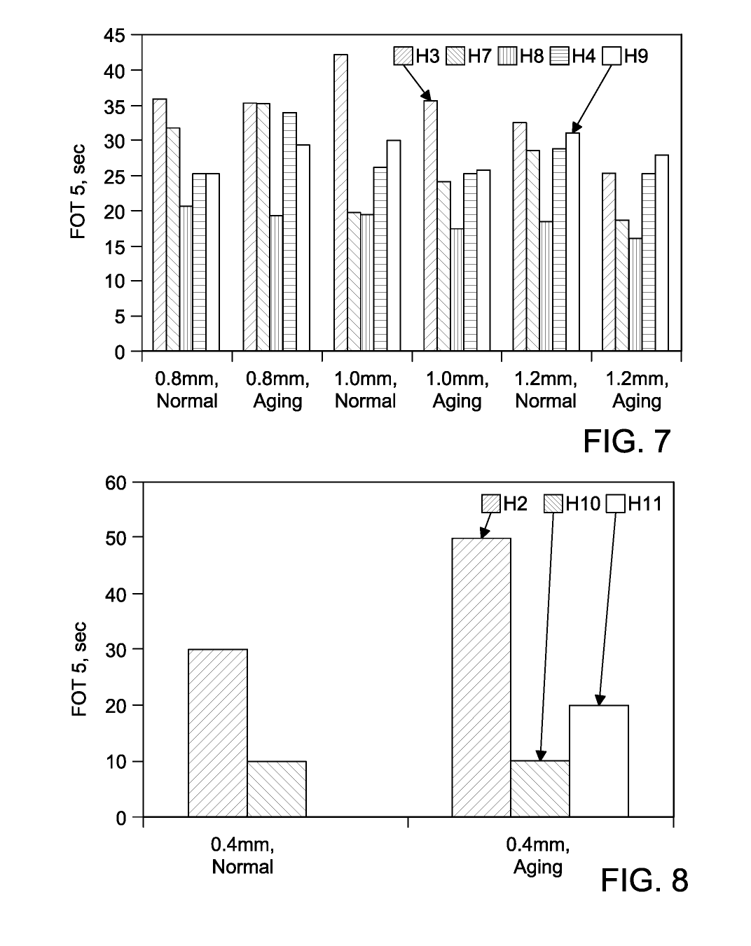

Example 2.4. Effect of Organic Fillers: A series of experiments were done to compare the properties of 9,T polyamide compositions made with a second Fire Retardant filler (ULTEM™ polyetherimide), as a function of the other compositional parameters (i.e., 30% flat glass fiber, 12% EXOLIT™ OP phosphinate salt and 3-5 wt % copper chromite oxide). The results are shown in Table 7 and FIG. 7.

TABLE 7
Effect of organic filler (ULTEM ™ PEI) as the second FR synergy agent.

| Item Code | Item Description | | Unit | H3 | H7 | H8 | H4 | H9 |
|---|---|---|---|---|---|---|---|---|
| C835503 | Kurary PA9T GC | | % | 54.7 | 52.7 | 42.7 | 52.7 | 52.7 |
| | 51010 polyamide | | | | | | | |
| F542 | PHOSPHITE | | % | 0.15 | 0.15 | 0.15 | 0.15 | 0.15 |
| | STABILIZER | | | | | | | |
| 25808 | Phenolic prim | | % | 0.15 | 0.15 | 0.15 | 0.15 | 0.15 |
| | antioxidant for | | | | | | | |
| | PA | | | | | | | |
| F594825 | Shepherd Black 1G | | % | 3 | 3 | 3 | 5 | 5 |
| 4027 | EXOLIT OP | | % | 12 | 12 | 12 | 12 | 10 |
| | 1230 | | | | | | | |
| C1150 | ULTEM ™ PEI | | % | | 2 | 12 | | 2 |
| (grinds) | grinds | | | | | | | |
| G512950 | Nittobo | | % | 30 | 30 | 30 | 30 | 30 |
| | (flat)glass fiber | | | | | | | |
| | CSG3PA820 | | | | | | | |
| Typical | | | | | | | | |
| Property | Test Method | Test Description | Unit | H3 | H7 | H8 | H4 | H9 |
| MVR | ASTM D 1238 | 310° C./1.2 kg/360 s | cm³/10 | 26 | 25 | 14 | 25 | 26 |
| | | | min | | | | | |
| Spiral flow | SABIC method | 310° C., 130° C., | cm | 24 | 23 | 19 | 23 | 24 |
| | | 1.0 mm | | | | | | |
| Spiral flow | SABIC method | 310° C., 130° C., | cm | 15 | 15 | 12 | 15 | 16 |
| | | 0.75 mm | | | | | | |
| HDT | ASTM D 648 | 0.45 MPa/3.2 mm | ° C. | >280 | >280 | >280 | >280 | >280 |
| HDT | ASTM D 648 | 1.82 MPa/3.2 mm | ° C. | 266 | 267 | 260 | 266 | 265 |
| Flexual | ASTM D 790 | 3.2 mm, | MPa | 8720 | 9050 | 9440 | 8930 | 8560 |
| Modulus | | 1.27 mm/min | | | | | | |
| Flexual | ASTM D 790 | yield, 3.2 mm, | MPa | 154 | 157 | 149 | 151 | 149 |
| Strength | | 1.27 mm/min | | | | | | |
| Tensile | ASTM D 638 | 5 mm/min | MPa | 9454 | 9705 | 9893 | 9678 | 9451 |
| Modulus | | | | | | | | |
| Tensile | ASTM D 638 | break, 5 mm/min | MPa | 104 | 106 | 98 | 100 | 100 |
| Strength | | | | | | | | |
| Tensile | ASTM D 638 | break, 5 mm/min | % | 1.5 | 1.5 | 1.3 | 1.5 | 1.4 |
| Elongation | | | | | | | | |
| Notched | ASTM D256 | 23° C., 2 lbf/ft | J/m | 41 | 42 | 39 | 40 | 38 |
| Izod | | | | | | | | |
| Unnotched | ASTM D256 | 23° C., 5 lbf/ft | J/m | 379 | 340 | 321 | 380 | 323 |
| Izod | | | | | | | | |
| Dielectric | | 1 GHz | | 3.547 | 3.583 | 3.583 | 3.607 | 3.603 |
| Constant | | | | | | | | |
| Dissipation | | 1 GHz | | 0.010 | 0.011 | 0.009 | 0.010 | 0.010 |
| Factor | | | | | | | | |
| Moisture | ISO 62 | 23° C., 24 hours | % | | | | | |
| Moisture | ISO 62 | 23° C., 312 hours | % | | | | | |
| Plating | | | | | | | | |
| Index | | | | | | | | |
| Drops | 0.8 mm, normal | | | 0 | 0 | 0 | 0 | 0 |
| p(FTP) V0 | 0.8 mm, normal | | | 0.9 | 1.0 | 1.0 | 1.0 | 1.0 |
| FOT 5 | 0.8 mm, normal | | second | 36 | 32 | 21 | 25 | 25 |
| Drops | 0.8 mm, aging | | | 0 | 0 | 0 | 0 | 0 |
| p(FTP) V0 | 0.8 mm, aging | | | 0.9 | 0.7 | 1.0 | 0.7 | 1.0 |
| FOT 5 | 0.8 mm, aging | | second | 35 | 35 | 19 | 34 | 29 |
| Drops | 1.0 mm, normal | | | 0 | 0 | 0 | 0 | 0 |
| p(FTP) V0 | 1.0 mm, normal | | | 0.5 | 1.0 | 1.0 | 1.0 | 1.0 |
| FOT 5 | 1.0 mm, normal | | second | 42 | 20 | 20 | 26 | 30 |
| Drops | 1.0 mm, aging | | | 0 | 0 | 0 | 0 | 0 |
| p(FTP) V0 | 1.0 mm, aging | | | 0.9 | 1.0 | 1.0 | 1.0 | 1.0 |
| FOT 5 | 1.0 mm, aging | | second | 36 | 24 | 17 | 25 | 26 |
| Drops | 1.2 mm, normal | | | 0 | 0 | 0 | 0 | 0 |
| p(FTP) V0 | 1.2 mm, normal | | | 0.9 | 0.9 | 1.0 | 1.0 | 1.0 |
| FOT 5 | 1.2 mm, normal | | second | 33 | 29 | 19 | 29 | 31 |
| Drops | 1.2 mm, aging | | | 0 | 0 | 0 | 0 | 0 |
| p(FTP) V0 | 1.2 mm, aging | | | 1.0 | 1.0 | 1.0 | 1.0 | 1.0 |
| FOT 5 | 1.2 mm, aging | | second | 25 | 19 | 16 | 26 | 28 |

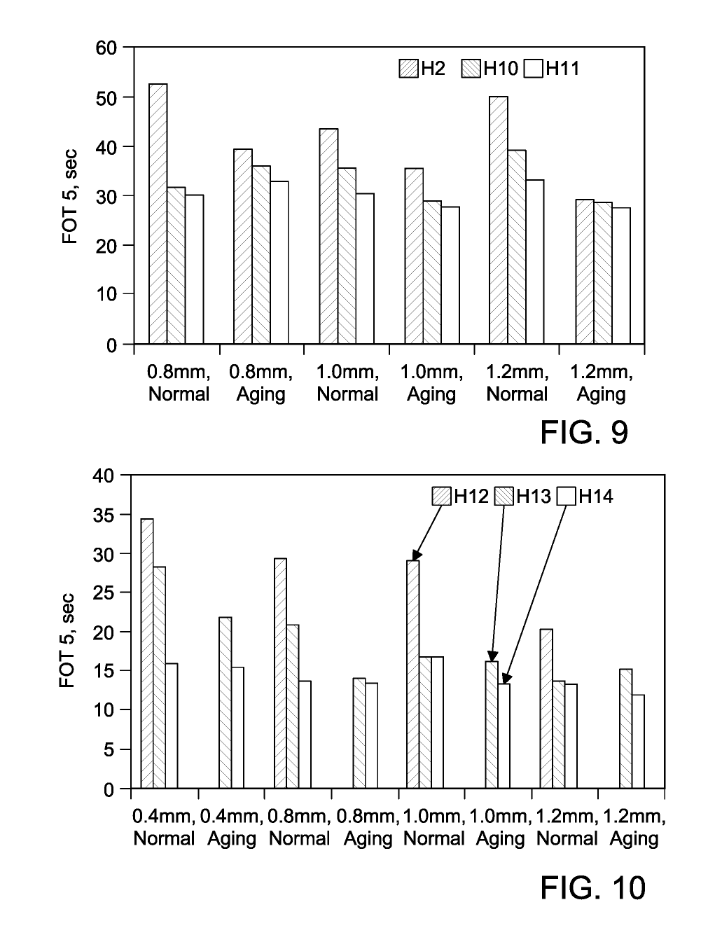

Example 2.5. Effect of Metallic Fillers: A series of experiments were done to compare the properties of 9,T polyamide compositions made with aluminum as a second Fire Retardant filler, as a function of the other compositional parameters (i.e., 30% flat glass fiber, 12% EXOLIT™ OP phosphinate salt and 2% copper chromite oxide). The results are shown in Table 8 and FIGS. 8 and 9. The results show that extremely low loadings of aluminum, of any morphology (needles or flakes), can provide beneficial improvements in performance.

TABLE 8
Effect of Aluminum as the second FR synergy agent. The FOTs are further shown in FIG. 5.

| Item Code | Item Description | | Unit | H2 | H10 | H11 |
|---|---|---|---|---|---|---|
| C835503 | Kurary PA9T GC | | % | 55.7 | 55.1 | 55.2 |
| | 51010 polyamide | | | | | |
| F542 | PHOSPHITE | | % | 0.15 | 0.15 | 0.15 |
| | STABILIZER | | | | | |
| 25808 | Phenolic prim | | % | 0.15 | 0.15 | 0.15 |
| | antioxidant for PA | | | | | |
| F594825 | Shepherd Black 1G | | % | 2 | 2 | 2 |
| | chromite spinel | | | | | |
| R09132 | aluminum flake, 25 | | % | | 0.625 | |
| | micron, 80% in PMMA | | | | | |
| F550081 | Aluminum needles, | | % | | | 0.5 |
| | Transmet | | | | | |
| 4027 | EXOLIT OP 1230 | | % | 12 | 12 | 12 |
| G512950 | Nittobo (flat)glass | | % | 30 | 30 | 30 |
| | fiber CSG3PA820 | | | | | |
| Typical | | | | | | |
| Property | Test Method | Test Description | Unit | H2 | H10 | H11 |
| MVR | ASTM D 1238 | 310° C./1.2 kg/360 s | cm³/10 | 28 | 27 | 30 |
| | | | min | | | |
| Spiral flow | SABIC method | 310° C., 130° C., | cm | 24 | 23 | 25 |
| | | 1.0 mm | | | | |
| Spiral flow | SABIC method | 310° C., 130° C., | cm | 15 | 15 | 16 |
| | | 0.75 mm | | | | |
| HDT | ASTM D 648 | 0.45 MPa/3.2 mm | ° C. | >280 | >280 | >280 |
| HDT | ASTM D 648 | 1.82 MPa/3.2 mm | ° C. | 267 | 267 | 266 |
| Flexual | ASTM D 790 | 3.2 mm, | MPa | 8460 | 8370 | 8260 |
| Modulus | | 1.27 mm/min | | | | |
| Flexual | ASTM D 790 | yield, 3.2 mm, | MPa | 152 | 152 | 152 |
| Strength | | 1.27 mm/min | | | | |
| Tensile | ASTM D 638 | 5 mm/min | MPa | 9416 | 9633 | 9335 |
| Modulus | | | | | | |
| Tensile | ASTM D 638 | break, 5 mm/min | MPa | 104 | 106 | 93 |
| Strength | | | | | | |
| Tensile | ASTM D 638 | break, 5 mm/min | % | 1.6 | 1.6 | 1.3 |
| Elongation | | | | | | |
| Notched | ASTM D256 | 23° C., 2 lbf/ft | J/m | 43 | 41 | 41 |
| Izod | | | | | | |
| Unnotched | ASTM D256 | 23° C., 5 lbf/ft | J/m | 377 | 363 | 299 |
| Izod | | | | | | |
| Dielectric | | 1 GHz | | 3.527 | 3.670 | 3.553 |
| Constant | | | | | | |
| Dissipation | | 1 GHz | | 0.010 | 0.021 | 0.010 |
| Factor | | | | | | |
| Moisture | ISO 62 | 23° C., 24 hours | % | | | |
| Moisture | ISO 62 | 23° C., 312 hours | % | | | |
| Plating | | | | | | |
| Index | | | | | | |
| Drops | 0.4 mm, normal | | | 3 | 1 | 0 |
| p(FTP) V0 | 0.4 mm, normal | | | 0.1 | 0.5 | 1.0 |
| FOT 5 | 0.4 mm, normal | | second | 31 | 39 | 30 |
| Drops | 0.4 mm, aging | | | 5 | 1 | 2 |
| p(FTP) V0 | 0.4 mm, aging | | | 0.0 | 0.6 | 0.3 |
| FOT 5 | 0.4 mm, aging | | second | 34 | 34 | 29 |
| Drops | 0.8 mm, normal | | | 0 | 0 | 0 |
| p(FTP) V0 | 0.8 mm, normal | | | 0.1 | 0.9 | 1.0 |
| FOT 5 | 0.8 mm, normal | | second | 53 | 32 | 30 |
| Drops | 0.8 mm, aging | | | 0 | 0 | 0 |
| p(FTP) V0 | 0.8 mm, aging | | | 0.6 | 1.0 | 1.0 |
| FOT 5 | 0.8 mm, aging | | second | 39 | 36 | 33 |
| Drops | 1.0 mm, normal | | | 0 | 0 | 0 |
| p(FTP) V0 | 1.0 mm, normal | | | 0.6 | 1.0 | 1.0 |
| FOT 5 | 1.0 mm, normal | | second | 43 | 36 | 31 |
| Drops | 1.0 mm, aging | | | 0 | 0 | 0 |
| p(FTP) V0 | 1.0 mm, aging | | | 0.8 | 1.0 | 1.0 |
| FOT 5 | 1.0 mm, aging | | second | 36 | 29 | 28 |
| Drops | 1.2 mm, normal | | | 0 | 0 | 0 |
| p(FTP) V0 | 1.2 mm, normal | | | 0.2 | 0.5 | 0.9 |
| FOT 5 | 1.2 mm, normal | | second | 50 | 39 | 33 |
| Drops | 1.2 mm, aging | | | 0 | 0 | 0 |
| p(FTP) V0 | 1.2 mm, aging | | | 1.0 | 1.0 | 1.0 |
| FOT 5 | 1.2 mm, aging | | second | 29 | 29 | 28 |

Example 2.6. High Loadings of EXOLIT™ OP phosphinate salt and Glass Fibers: A series of experiments were done to compare the properties of various 9,T polyamide compositions made with high loadings of EXOLIT™ OP phosphinate salt, as a function of the other compositional parameters (i.e., 30 or 40% flat glass fiber, 0 or 12% EXOLIT™ OP phosphinate salt and 0 or 2% copper chromite oxide). See Table 9 and FIG. 10.

TABLE 9
Effect of high loadings of EXOLIT ™ OP phosphinate salt in polyamide polyamide composites.

| Item Code | Item Description | | Unit | H12 | H13 | H14 | H15 |
|---|---|---|---|---|---|---|---|
| C835503 | Kurary PA9T GC | | % | 49.7 | 46.7 | 34.7 | 36.7 |
| | 51010 polyamide | | | | | | |
| F542 | PHOSPHITE | | % | 0.15 | 0.15 | 0.15 | 0.15 |
| | STABILIZER | | | | | | |
| 25808 | Phenolic prim | | % | 0.15 | 0.15 | 0.15 | 0.15 |
| | antioxidant for PA | | | | | | |
| F594825 | Shepherd Black 1G | | % | | 3 | 3 | 3 |
| | chromite spinel | | | | | | |
| 4027 | EXOLIT OP 1230 | | % | 20 | 20 | 20 | 20 |
| C1150 | ULTEM ™ PEI | | % | | | 12 | |
| (grinds) | grinds | | | | | | |
| G512950 | Nittobo (flat)glass | | % | 30 | 30 | 30 | 40 |
| | fiber CSG3PA820 | | | | | | |
| Typical | | | | | | | |
| Property | Test Method | Test Description | Unit | H12 | H13 | H14 | H15 |
| MVR | ASTM D 1238 | 310° C./1.2 kg/360 s | cm³/10 | 16 | 16 | 5 | 2 |
| | | | min | | | | |
| Spiral flow | SABIC method | 310° C., 130° C., | cm | 23 | 22 | 20 | 19 |
| | | 1.0 mm | | | | | |
| Spiral flow | SABIC method | 310° C., 130° C., | cm | 14 | 14 | 12 | 11 |
| | | 0.75 mm | | | | | |
| HDT | ASTM D 648 | 0.45 MPa/3.2 mm | ° C. | >280 | >280 | >280 | |
| HDT | ASTM D 648 | 1.82 MPa/3.2 mm | ° C. | 274 | 266 | 257 | |
| Flexual | ASTM D 790 | 3.2 mm, | MPa | 9830 | 9580 | 10100 | 12100 |
| Modulus | | 1.27 mm/min | | | | | |
| Flexual | ASTM D 790 | yield, 3.2 mm, | MPa | 203 | 145 | 133 | 155 |
| Strength | | 1.27 mm/min | | | | | |
| Tensile | ASTM D 638 | 5 mm/min | MPa | 10368 | 10040 | 10524 | 13109 |
| Modulus | | | | | | | |
| Tensile | ASTM D 638 | break, 5 mm/min | MPa | 131 | 99 | 89 | 103 |
| Strength | | | | | | | |
| Tensile | ASTM D 638 | break, 5 mm/min | % | 2.0 | 1.6 | 1.2 | 1.2 |
| Elongation | | | | | | | |
| Notched | ASTM D256 | 23° C., 2 lbf/ft | J/m | 83 | 42 | 39 | 43 |
| Izod | | | | | | | |
| Unnotched | ASTM D256 | 23° C., 5 lbf/ft | J/m | 651 | 316 | 258 | 249 |
| Izod | | | | | | | |
| Dielectric | | 1 GHz | | 3.527 | 3.570 | 3.627 | 3.820 |
| Constant | | | | | | | |
| Dissipation | | 1 GHz | | 0.009 | 0.010 | 0.008 | 0.010 |
| Factor | | | | | | | |
| Moisture | ISO 62 | 23° C., 24 hours | % | | | | |
| Moisture | ISO 62 | 23° C., 312 hours | % | | | | |
| Plating | | | | | | | |
| Index | | | | | | | |
| Drops | 0.4 mm, normal | | | 0 | 0 | 0 | |
| p(FTP) V0 | 0.4 mm, normal | | | 0.5 | 0.8 | 1.0 | |
| FOT 5 | 0.4 mm, normal | | second | 34 | 28 | 16 | |
| Drops | 0.4 mm, aging | | | | 0 | 0 | |
| p(FTP) V0 | 0.4 mm, aging | | | | 1.0 | 1.0 | |
| FOT 5 | 0.4 mm, aging | | second | | 22 | 15 | |
| Drops | 0.8 mm, normal | | | 0 | 0 | 0 | |
| p(FTP) V0 | 0.8 mm, normal | | | 0.8 | 1.0 | 1.0 | |
| FOT 5 | 0.8 mm, normal | | second | 29 | 21 | 14 | |
| Drops | 0.8 mm, aging | | | | 0 | 0 | |
| p(FTP) V0 | 0.8 mm, aging | | | | 1.0 | 1.0 | |
| FOT 5 | 0.8 mm, aging | | second | | 14 | 13 | |
| Drops | 1.0 mm, normal | | | 0 | 0 | 0 | |
| p(FTP) V0 | 1.0 mm, normal | | | 0.9 | 1.0 | 1.0 | |
| FOT 5 | 1.0 mm, normal | | second | 29 | 17 | 17 | |
| Drops | 1.0 mm, aging | | | | 0 | 0 | |
| p(FTP) V0 | 1.0 mm, aging | | | | 1.0 | 1.0 | |
| FOT 5 | 1.0 mm, aging | | second | | 16 | 14 | |
| Drops | 1.2 mm, normal | | | 0 | 0 | 0 | |
| p(FTP) V0 | 1.2 mm, normal | | | 0.9 | 1.0 | 1.0 | |
| FOT 5 | 1.2 mm, normal | | second | 20 | 14 | 13 | |
| Drops | 1.2 mm, aging | | | | 0 | 0 | |
| p(FTP) V0 | 1.2 mm, aging | | | | 1.0 | 1.0 | |
| FOT 5 | 1.2 mm, aging | | second | | 15 | 12 | |

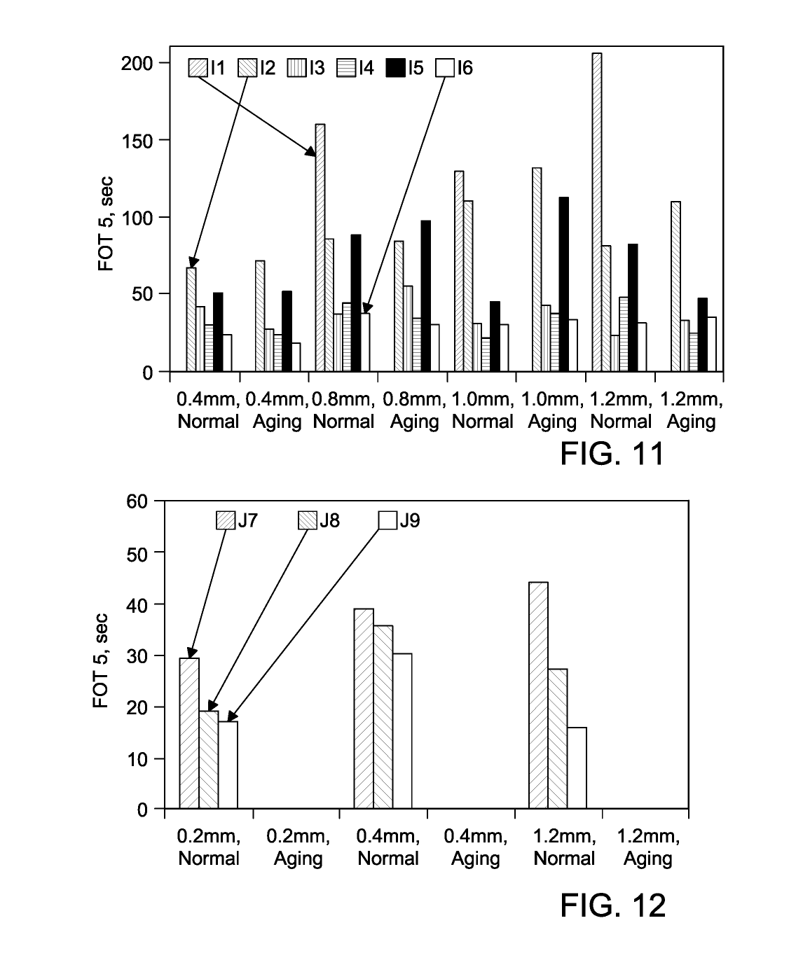

Example 2.7. Effect of Circular Cross-Section Fibers: 12% EXOLIT™ OP phosphinate salt. A series of experiments were done to compare the properties of 9,T polyimide compositions made with circular cross-sectional glass fibers (to compare with flat glass fibers in preceding tables), as a function of the other compositional parameters (i.e., 30% glass fiber, 0 or 3% copper chromite oxide, and 0, 12, or 20% ULTEM™ polyetherimide). The results are shown in Table 10 and FIG. 11.

TABLE 10
Effect of various compositional additives on 9,T polyamide composites containing thin, circular cross-sectional glass fibers.

| Item Code | Item Description | | Unit | I1 | I2 | I3 | I4 | I5 | I6 |
|---|---|---|---|---|---|---|---|---|---|
| C835991 | Kurary PA9T | | % | | | | | 27.4 | 17.4 |
| | GC48020 | | | | | | | | |
| C835503 | Kurary PA9T | | % | 57.7 | 54.7 | 42.7 | 34.7 | 27.3 | 17.3 |
| | GC 51010 | | | | | | | | |
| F542 | PHOSPHITE | | % | 0.15 | 0.15 | 0.15 | 0.15 | 0.15 | 0.15 |
| | STABILIZER | | | | | | | | |
| 25808 | Phenolic prim | | % | 0.15 | 0.15 | 0.15 | 0.15 | 0.15 | 0.15 |
| | antioxidant for | | | | | | | | |
| | PA | | | | | | | | |
| F594827 | BLACK 30C965 | | % | 0 | 3 | 3 | 3 | 3 | 3 |
| 4027 | EXOLIT OP | | % | 12 | 12 | 12 | 12 | 12 | 12 |
| | 1230 | | | | | | | | |
| C1150 | ULTEM ™ PEI | | % | | | 12 | 20 | | 20 |
| (grinds) | grinds | | | | | | | | |
| G513189 | Glass Fiber | | % | 30 | 30 | 30 | 30 | 30 | 30 |
| | CPIC ECS- | | | | | | | | |
| | 301HP (E)- | | | | | | | | |
| | 7.5 um/3 mm | | | | | | | | |
| Typical | | | | | | | | | |
| Property | Test Method | Test Description | Unit | I1 | I2 | I3 | I4 | I5 | I6 |
| MVR | ASTM D 1238 | 310° C./1.2 kg/360 s | cm³/10 | 25 | 26 | 10 | 5 | 27 | 4 |
| | | | min | | | | | | |
| Spiral flow | SABIC method | 310° C., 130° C., | cm | 25 | 25 | 16 | 17 | 24 | 18 |
| | | 1.0 mm | | | | | | | |
| Spiral flow | SABIC method | 310° C., 130° C., | cm | 16 | 12 | 11 | 11 | 14 | 11 |
| | | 0.75 mm | | | | | | | |
| HDT | ASTM D 648 | 0.45 MPa/3.2 mm | ° C. | >280 | >280 | 280 | >280 | 274 | 260 |
| HDT | ASTM D 648 | 1.82 MPa/3.2 mm | ° C. | 275 | 265 | 267 | 253 | 252 | 234 |
| Flexual | ASTM D 790 | 3.2 mm, | MPa | 9200 | 9144 | 9260 | 9770 | 9150 | 9600 |
| Modulus | | 1.27 mm/min | | | | | | | |
| Flexual | ASTM D 790 | yield, 3.2 mm, | MPa | 250 | 174 | 162 | 163 | 178 | 159 |
| Strength | | 1.27 mm/min | | | | | | | |
| Tensile | ASTM D 638 | 5 mm/min | MPa | 9810 | 9990 | 9918 | 10558 | 9948 | 10678 |
| Modulus | | | | | | | | | |
| Tensile | ASTM D 638 | break, 5 mm/min | MPa | 163 | 123 | 117 | 119 | 130 | 118 |
| Strength | | | | | | | | | |
| Tensile | ASTM D 638 | break, 5 mm/min | % | 2.5 | 1.7 | 1.6 | 1.6 | 1.9 | 1.5 |
| Elongation | | | | | | | | | |
| Notched | ASTM D256 | 23° C., 2 lbf/ft | J/m | 89 | 35 | 35 | 31 | 37 | 36 |
| Izod | | | | | | | | | |
| Unnotched | ASTM D256 | 23° C., 5 lbf/ft | J/m | 1120 | 407 | 450 | 245 | 528 | 373 |
| Izod | | | | | | | | | |
| Dielectric | | 1 GHz | | 3.473 | | 3.527 | 3.593 | 3.537 | 3.557 |
| Constant | | | | | | | | | |
| Dissipation | | 1 GHz | | 0.010 | | 0.009 | 0.008 | 0.010 | 0.008 |
| Factor | | | | | | | | | |
| Moisture | ISO 62 | 23° C., 24 hours | % | | | | | | |
| Moisture | ISO 62 | 23° C., 312 hours | % | | | | | | |
| Plating | | | | | | | | | |
| Index | | | | | | | | | |
| Drops | 0.4 mm, normal | | | 1 | 0 | 0 | 0 | 0 | 0 |
| p(FTP) V0 | 0.4 mm, normal | | | 0.01 | 0.0 | 0.5 | 1.0 | 0.2 | 1.0 |
| FOT 5 | 0.4 mm, normal | | second | 55.9 | 66 | 42 | 30 | 51 | 24 |
| Drops | 0.4 mm, aging | | | | 0 | 0 | 0 | 0 | 0 |
| p(FTP) V0 | 0.4 mm, aging | | | | 0.0 | 1.0 | 1.0 | 0.2 | 1.0 |
| FOT 5 | 0.4 mm, aging | | second | | 72 | 27 | 25 | 52 | 19 |
| Drops | 0.8 mm, normal | | | 0 | 0 | 0 | 0 | 0 | 0 |
| p(FTP) V0 | 0.8 mm, normal | | | 0.0 | 0.0 | 0.4 | 0.8 | 0.0 | 0.9 |
| FOT 5 | 0.8 mm, normal | | second | 160 | 86 | 37 | 45 | 89 | 38 |
| Drops | 0.8 mm, aging | | | | 0 | 0 | 0 | 0 | 0 |
| p(FTP) V0 | 0.8 mm, aging | | | | 0.0 | 0.1 | 0.9 | 0.0 | 0.8 |
| FOT 5 | 0.8 mm, aging | | second | | 85 | 56 | 34 | 98 | 30 |
| Drops | 1.0 mm, normal | | | 0 | 0 | 0 | 0 | 0 | 0 |
| p(FTP) V0 | 1.0 mm, normal | | | 0.0 | 0.0 | 0.7 | 1.0 | 0.5 | 0.9 |
| FOT 5 | 1.0 mm, normal | | second | 130 | 111 | 31 | 22 | 45 | 31 |
| Drops | 1.0 mm, aging | | | | 0 | 0 | 0 | 0 | 0 |
| p(FTP) V0 | 1.0 mm, aging | | | | 0.0 | 0.5 | 0.6 | 0.0 | 0.9 |
| FOT 5 | 1.0 mm, aging | | second | | 132 | 43 | 38 | 113 | 34 |
| Drops | 1.2 mm, normal | | | 0 | 0 | 0 | 0 | 0 | 0 |
| p(FTP) V0 | 1.2 mm, normal | | | 0.0 | 0.0 | 1.0 | 0.3 | 0.0 | 1.0 |
| FOT 5 | 1.2 mm, normal | | second | 206 | 81 | 23 | 48 | 82 | 32 |
| Drops | 1.2 mm, aging | | | | 0 | 0 | 0 | 0 | 0 |
| p(FTP) V0 | 1.2 mm, aging | | | | 0.0 | 0.7 | 1.0 | 0.3 | 0.6 |
| FOT 5 | 1.2 mm, aging | | second | | 110 | 33 | 25 | 47 | 36 |

Example 2.7. Effect of Circular Cross-Section Fibers: 20% EXOLIT™ OP phosphinate salt. A series of experiments were done to compare the properties of 9,T polyamide compositions made with circular cross-sectional glass fibers, as a function of the other compositional parameters (i.e., 30% circular cross-section glass fiber, 20% EXOLIT™ OP phosphinate salt, 0 or 3% copper chromite oxide). See Table 11 and FIG. 12.

TABLE 11
Effect of mixed cross-sectional glass fibers on performance of 9,T polyamide

| Item Code | Item Description | | Unit | I7 | I8 | I9 |
|---|---|---|---|---|---|---|
| C835991 | Kurary PA9T GC48020 | | % | | | 15 |
| C835503 | Kurary PA9T GC 51010 | | % | 49.7 | 46.7 | 31.7 |
| F542 | PHOSPHITE STABILIZER | | % | 0.15 | 0.15 | 0.15 |
| 25808 | Phenolic prim antioxidant for PA | | % | 0.15 | 0.15 | 0.15 |
| F594825 | Shepherd Black 1G | | % | 0 | 3 | 3 |
| 4027 | EXOLIT OP 1230 | | % | 20 | 20 | 20 |
| G513189 | Glass Fiber CPIC | | % | 30 | 30 | 30 |
| | ECS-301HP (E)- | | | | | |
| | 7.5 um/3 mm | | | | | |
| Typical | | | | | | |
| Property | Test Method | Test Description | Unit | I7 | I8 | I9 |
| MVR | ASTM D 1238 | 310° C./1.2 kg/360 s | cm³/10 | 10 | 7 | 7 |
| | | | min | | | |
| Spiral flow | SABIC method | 310° C., 130° C., | cm | 22 | 19 | 20 |
| | | 1.0 mm | | | | |
| Spiral flow | SABIC method | 310° C., 130° C., | cm | 12 | 11 | 12 |
| | | 0.75 mm | | | | |
| HDT | ASTM D 648 | 0.45 MPa/3.2 mm | ° C. | >280 | >280 | >280 |
| HDT | ASTM D 648 | 1.82 MPa/3.2 mm | ° C. | 276 | 270 | 258 |
| Flexual | ASTM D 790 | 3.2 mm, | MPa | 9750 | 9780 | 9910 |
| Modulus | | 1.27 mm/min | | | | |
| Flexual | ASTM D 790 | yield, 3.2 mm, | MPa | 231 | 167 | 162 |
| Strength | | 1.27 mm/min | | | | |
| Tensile | ASTM D 638 | 5 mm/min | MPa | 10442 | 10440 | 10528 |
| Modulus | | | | | | |
| Tensile | ASTM D 638 | break, 5 mm/min | MPa | 151 | 115 | 113 |
| Strength | | | | | | |
| Tensile | ASTM D 638 | break, 5 mm/min | % | 2.4 | 1.7 | 1.7 |
| Elongation | | | | | | |
| Notched | ASTM D256 | 23° C., 2 lbf/ft | J/m | 84 | 39 | 40 |
| Izod | | | | | | |
| Unnotched | ASTM D256 | 23° C., 5 lbf/ft | J/m | 851 | 536 | 545 |
| Izod | | | | | | |
| Dielectric | | 1 GHz | | 3.483 | 3.530 | 3.560 |
| Constant | | | | | | |
| Dissipation | | 1 GHz | | 0.009 | 0.010 | 0.010 |
| Factor | | | | | | |
| Moisture | ISO 62 | 23° C., 24 hours | % | | | |
| Moisture | ISO 62 | 23° C., 312 hours | % | | | |
| Plating | | | | | | |
| Index | | | | | | |
| Drops | 0.2 mm, normal | | | 0 | 0 | 0 |
| p(FTP) V0 | 0.2 mm, normal | | | 0.7 | 1.0 | 1.0 |
| FOT 5 | 0.2 mm, normal | | second | 29 | 19 | 17 |
| Drops | 0.2 mm, aging | | | | | |
| p(FTP) V0 | 0.2 mm, aging | | | | | |
| FOT 5 | 0.2 mm, aging | | second | | | |
| Drops | 0.4 mm, normal | | | 0 | 0 | 0 |
| p(FTP) V0 | 0.4 mm, normal | | | 0.0 | 0.5 | 0.9 |
| FOT 5 | 0.4 mm, normal | | second | 39 | 36 | 31 |
| Drops | 0.4 mm, aging | | | | | |
| p(FTP) V0 | 0.4 mm, aging | | | | | |
| FOT 5 | 0.4 mm, aging | | second | | | |
| Drops | 1.2 mm, normal | | | 0 | 0 | 0 |
| p(FTP) V0 | 1.2 mm, normal | | | 0.2 | 0.8 | 1.0 |
| FOT 5 | 1.2 mm, normal | | second | 44 | 27 | 16 |
| Drops | 1.2 mm, aging | | | | | |
| p(FTP) V0 | 1.2 mm, aging | | | | | |
| FOT 5 | 1.2 mm, aging | | second | | | |

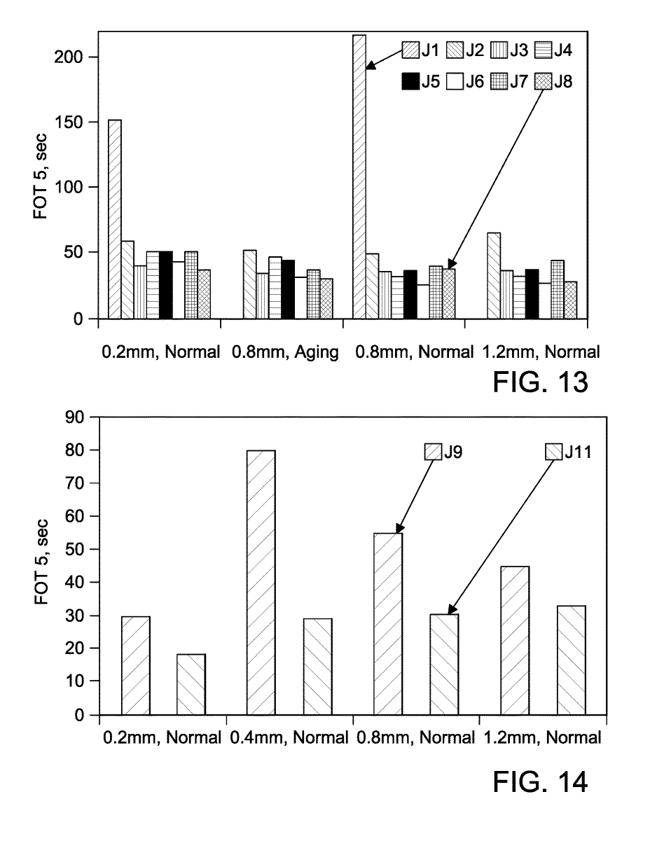

Example 2.8. Effect of Mixed Fibers. A series of experiments were done to compare the properties of 9,T polyamide compositions made with circular cross-sectional glass fibers, as a function of the other compositional parameters (i.e., 30% mixed glass fiber, 12% EXOLIT™ OP phosphinate salt, 0 or 3% copper chromite oxide, 0, 12, or 20% ULTEM™ polyetherimide, and aluminum). The results are shown in Tables 12a-12b and FIG. 13.

TABLE 12a
Effect of various compositional parameters on 9,T polyamide composites
comprising mixed cross-sectional form glass fibers.

| Item Code | Item Description | | Unit | J1 | J2 | J3 | J4 |
|---|---|---|---|---|---|---|---|
| C835991 | Kurary PA9T | | % | | | | |
| | GC48020 | | | | | | |
| C835503 | Kurary PA9T | | % | 57.7 | 54.7 | 54.075 | 54.2 |
| | GC 51010 | | | | | | |
| F542 | PHOSPHITE | | % | 0.15 | 0.15 | 0.15 | 0.15 |
| | STABILIZER | | | | | | |
| 25808 | Phenolic prim | | % | 0.15 | 0.15 | 0.15 | 0.15 |
| | antioxidant | | | | | | |
| | for PA | | | | | | |
| F594827 | BLACK | | % | | 3 | 3 | 3 |
| | 30C965 | | | | | | |
| R09132 | aluminum | | % | | | 0.625 | |
| | flake, 25 | | | | | | |
| | micron, 80% | | | | | | |
| | in PMMA | | | | | | |
| F550081 | Aluminum | | % | | | | 0.5 |
| | needles, | | | | | | |
| | Transmet | | | | | | |
| 4027 | EXOLIT OP | | % | 12 | 12 | 12 | 12 |
| | 1230 | | | | | | |
| C1150 | ULTEM ™ | | % | | | | |
| (grinds) | PEI grinds | | | | | | |
| G512950 | Nittobo | | % | 18 | 18 | 18 | 18 |
| | (flat)glass | | | | | | |
| | fiber | | | | | | |
| | CSG3PA820 | | | | | | |
| G513189 | Glass Fiber | | % | 12 | 12 | 12 | 12 |
| | CPIC ECS- | | | | | | |
| | 301HP (E)- | | | | | | |
| | 7.5 um/3 mm | | | | | | |
| Typical | | | | | | | |
| Property | Test Method | Test Description | Unit | J1 | J2 | J3 | J4 |
| MVR | ASTM D 1238 | 310° C./1.2 kg/360 s | cm³/10 | | 36 | 33 | 35 |
| | | | min | | | | |
| Spiral | SABIC method | 310° C., 130° C., | cm | | 31 | 25 | 26 |
| flow | | 1.0 mm | | | | | |
| Spiral | SABIC method | 310° C., 130° C., | cm | | 17 | 16 | 16 |
| flow | | 0.75 mm | | | | | |
| HDT | ASTM D 648 | 0.45 Mpa/3.2 mm | ° C. | >280 | >280 | >280 | >280 |
| HDT | ASTM D 648 | 1.82 Mpa/3.2 mm | ° C. | 277 | 268 | 265 | 266 |
| Flexual | ASTM D 790 | 3.2 mm, | MPa | 9170 | 8750 | 8829 | 8687 |
| Modulus | | 1.27 mm/min | | | | | |
| Flexual | ASTM D 790 | yield, 3.2 mm, | MPa | 224 | 168 | 161 | 161 |
| Strength | | 1.27 mm/min | | | | | |
| Tensile | ASTM D 638 | 5 mm/min | MPa | 9742 | 9895 | 9577 | 9464 |
| Modulus | | | | | | | |
| Tensile | ASTM D 638 | break, 5 mm/min | MPa | 146 | 119 | 107 | 90 |
| Strength | | | | | | | |
| Tensile | ASTM D 638 | break, 5 mm/min | % | 2.1 | 1.7 | 1.5 | 1.2 |
| Elongation | | | | | | | |
| Notched | ASTM D256 | 23° C., 2 lbf/ft | J/m | 98 | 41 | 38 | 37 |
| Izod | | | | | | | |
| Unnotched | ASTM D256 | 23° C., 5 lbf/ft | J/m | 878 | 412 | 384 | 322 |
| Izod | | | | | | | |
| Dielectric | | 1 GHz | | 3.477 | 3.490 | | |
| Constant | | | | | | | |
| Dissipation | | 1 GHz | | 0.010 | 0.010 | | |
| Factor | | | | | | | |
| Moisture | ISO 62 | 23° C., 24 hours | % | | 0.03 | | |
| Moisture | ISO 62 | 23° C., 312 hours | % | | 0.13 | | |
| Plating | | | | | | | |
| Index | | | | | | | |
| Drops | 0.4 mm, normal | | | 6 | 1 | 0 | 0 |
| p(FTP) V0 | 0.4 mm, normal | | | 0.0 | 0.0 | 0.7 | 0.2 |
| FOT 5 | 0.4 mm, normal | | second | 71 | 59 | 47 | 50 |
| Drops | 0.4 mm, aging | | | | 2 | 1 | 1 |
| p(FTP) V0 | 0.4 mm, aging | | | | 0.2 | 0.3 | 0.3 |
| FOT 5 | 0.4 mm, aging | | second | | 42 | 43 | 47 |
| Drops | 0.8 mm, normal | | | 0 | 0 | 0 | 0 |
| p(FTP) V0 | 0.8 mm, normal | | | 0.0 | 0.0 | 0.8 | 0.2 |
| FOT 5 | 0.8 mm, normal | | second | 151 | 59 | 40 | 50 |
| Drops | 0.8 mm, aging | | | | 0 | 0 | 0 |
| p(FTP) V0 | 0.8 mm, aging | | | | 0.2 | 0.9 | 0.7 |
| FOT 5 | 0.8 mm, aging | | second | | 51 | 34 | 46 |
| Drops | 1.2 mm, normal | | | 0 | 0 | 0 | 0 |
| p(FTP) V0 | 1.2 mm, normal | | | 0.0 | 0.3 | 0.9 | 0.9 |
| FOT 5 | 1.2 mm, normal | | second | 217 | 49 | 35 | 31 |
| Drops | 1.2 mm, aging | | | | 0 | 0 | 0 |
| p(FTP) V0 | 1.2 mm, aging | | | | 0.0 | 0.5 | 1.0 |
| FOT 5 | 1.2 mm, aging | | second | | 65 | 36 | 32 |

TABLE 12b
Effect of various compositional parameters on 9,T polyamide composites
comprising mixed cross-sectional form glass fibers.

| Item Code | Item Description | | Unit | J5 | J6 | J7 | J8 |
|---|---|---|---|---|---|---|---|
| C835991 | Kurary PA9T | | % | | | 27.4 | 17.4 |
| | GC48020 | | | | | | |
| C835503 | Kurary PA9T | | % | 52.7 | 42.7 | 27.3 | 17.3 |
| | GC 51010 | | | | | | |
| F542 | PHOSPHITE | | % | 0.15 | 0.15 | 0.15 | 0.15 |
| | STABILIZER | | | | | | |
| 25808 | Phenolic prim | | % | 0.15 | 0.15 | 0.15 | 0.15 |
| | antioxidant | | | | | | |
| | for PA | | | | | | |
| F594827 | BLACK | | % | 3 | 3 | 3 | 3 |
| | 30C965 | | | | | | |
| R09132 | aluminum | | % | | | | |
| | flake, 25 | | | | | | |
| | micron, 80% | | | | | | |
| | in PMMA | | | | | | |
| F550081 | Aluminum | | % | | | | |
| | needles, | | | | | | |
| | Transmet | | | | | | |
| 4027 | EXOLIT OP | | % | 12 | 12 | 12 | 12 |
| | 1230 | | | | | | |
| C1150 | ULTEM ™ | | % | 2 | 12 | | 20 |
| (grinds) | PEI grinds | | | | | | |
| G512950 | Nittobo | | % | 18 | 18 | 18 | 18 |
| | (flat)glass | | | | | | |
| | fiber | | | | | | |
| | CSG3PA820 | | | | | | |
| G513189 | Glass Fiber | | % | 12 | 12 | 12 | 12 |
| | CPIC ECS- | | | | | | |
| | 301HP(E)- | | | | | | |
| | 7.5 um/3 mm | | | | | | |
| Typical | | | | | | | |
| Property | Test Method | Test Description | Unit | J5 | J6 | J7 | J8 |
| MVR | ASTM D 1238 | 310° C./1.2 kg/360 s | cm³/10 | | | 40 | 6 |
| | | | min | | | | |
| Spiral flow | SABIC method | 310° C., 130° C., | cm | 26 | 18 | 29 | 22 |
| | | 1.0 mm | | | | | |
| Spiral flow | SABIC method | 310° C., 130° C., | cm | 14 | 11 | 18 | 15 |
| | | 0.75 mm | | | | | |
| HDT | ASTM D 648 | 0.45 Mpa/3.2 mm | ° C. | >280 | 280 | 273 | 262 |
| HDT | ASTM D 648 | 1.82 Mpa/3.2 mm | ° C. | 267 | 264 | 250 | 235 |
| Flexual | ASTM D 790 | 3.2 mm, | MPa | 8790 | 9270 | 8810 | 9060 |
| Modulus | | 1.27 mm/min | | | | | |
| Flexual | ASTM D 790 | yield, 3.2 mm, | MPa | 155 | 153 | 199 | 143 |
| Strength | | 1.27 mm/min | | | | | |
| Tensile | ASTM D 638 | 5 mm/min | MPa | 9354 | 9787 | 9854 | 10427 |
| Modulus | | | | | | | |
| Tensile | ASTM D 638 | break, 5 mm/min | MPa | 101 | 110 | 119 | 108 |
| Strength | | | | | | | |
| Tensile | ASTM D 638 | break, 5 mm/min | % | 1.5 | 1.6 | 1.8 | 1.4 |
| Elongation | | | | | | | |
| Notched | ASTM D256 | 23° C., 2 lbf/ft | J/m | 38 | 35 | 41 | 32 |
| Izod | | | | | | | |
| Unnotched | ASTM D256 | 23° C., 5 lbf/ft | J/m | 353 | 303 | 383 | 210 |
| Izod | | | | | | | |
| Dielectric | | 1 GHz | | | 3.547 | 3.563 | 3.570 |
| Constant | | | | | | | |
| Dissipation | | 1 GHz | | | 0.009 | 0.011 | 0.009 |
| Factor | | | | | | | |
| Moisture | ISO 62 | 23° C., 24 hours | % | | 0.05 | 0.04 | 0.03 |
| Moisture | ISO 62 | 23° C., 312 hours | % | | 0.12 | 0.14 | 0.14 |
| Plating | | | | | | | |
| Index | | | | | | | |
| Drops | 0.4 mm, normal | | | 0 | 0 | 0 | 0 |
| p(FTP) V0 | 0.4 mm, normal | | | 0.8 | 1.0 | 0.6 | 1.0 |
| FOT 5 | 0.4 mm, normal | | second | 40 | 30 | 45 | 31 |
| Drops | 0.4 mm, aging | | | 0 | 0 | 0 | 0 |
| p(FTP) V0 | 0.4 mm, aging | | | 0.1 | 0.7 | 0.9 | 1.0 |
| FOT 5 | 0.4 mm, aging | | second | 53 | 38 | 44 | 29 |
| Drops | 0.8 mm, normal | | | 0 | 0 | 0 | 0 |
| p(FTP) V0 | 0.8 mm, normal | | | 0.2 | 0.5 | 0.2 | 1.0 |
| FOT 5 | 0.8 mm, normal | | second | 50 | 43 | 50 | 37 |
| Drops | 0.8 mm, aging | | | 0 | 0 | 0 | 0 |
| p(FTP) V0 | 0.8 mm, aging | | | 0.4 | 1.0 | 0.9 | 1.0 |
| FOT 5 | 0.8 mm, aging | | second | 43 | 31 | 36 | 30 |
| Drops | 1.2 mm, normal | | | 0 | 0 | 0 | 0 |
| p(FTP) V0 | 1.2 mm, normal | | | 0.8 | 1.0 | 0.7 | 0.6 |
| FOT 5 | 1.2 mm, normal | | second | 36 | 25 | 39 | 37 |
| Drops | 1.2 mm, aging | | | 0 | 0 | 0 | 0 |
| p(FTP) V0 | 1.2 mm, aging | | | 0.8 | 1.0 | 0.8 | 1.0 |
| FOT 5 | 1.2 mm, aging | | second | 36 | 26 | 43 | 28 |

Example 2.9. Effect of Mixed Fibers. Another set of experiments was done to compare the properties of 9,T polyamide compositions made with circular cross-sectional glass fibers, as a function of the other compositional parameters (i.e., 30% mixed glass fiber, 14% EXOLIT™ OP phosphinate salt, 0 or 3% copper chromite oxide, and0 or 12% ULTEM™ polyetherimide). The results are shown in Table 13 and FIG. 14.

TABLE 13
Effect of various compositional parameters on 9,T polyamide composites
comprising mixed cross-sectional form glass fibers.

| Item Code | Item Description | | Unit | J9 | J10 | J11 |
|---|---|---|---|---|---|---|
| C835503 | Kurary PA9T GC 51010 | | % | 55.7 | 52.7 | 40.7 |
| F542 | PHOSPHITE STABILIZER | | % | 0.15 | 0.15 | 0.15 |
| 25808 | Phenolic prim antioxidant for PA | | % | 0.15 | 0.15 | 0.15 |
| F594825 | Shepherd Black 1G | | % | 0 | 3 | 3 |
| 4027 | EXOLIT OP 1230 | | % | 14 | 14 | 14 |
| C1150 | ULTEM ™ PEI grinds | | % | | | 12 |
| (grinds) | | | | | | |
| G512950 | Nittobo (flat)glass fiber | | % | 18 | 18 | 18 |
| | CSG3PA820 | | | | | |
| G513189 | Glass Fiber CPIC ECS-301HP | | % | 12 | 12 | 12 |
| | (E)-7.5 um/3 mm | | | | | |
| Typical | | | | | | |
| Property | Test Method | Test Description | Unit | J9 | J10 | J11 |
| MVR | ASTM D 1238 | 310° C./1.2 kg/360 s | cm³/10 | | | |
| | | | min | | | |
| Spiral flow | SABIC method | 310° C., 130° C., | cm | | | 19 |
| | | 1.0 mm | | | | |
| Spiral flow | SABIC method | 310° C., 130° C., | cm | | | 11 |
| | | 0.75 mm | | | | |
| HDT | ASTM D 648 | 0.45 MPa/3.2 mm | ° C. | >280 | >280 | 280 |
| HDT | ASTM D 648 | 1.82 MPa/3.2 mm | ° C. | 276 | 265 | 255 |
| Flexual | ASTM D 790 | 3.2 mm, | MPa | 9330 | 8545 | 8710 |
| Modulus | | 1.27 mm/min | | | | |
| Flexual | ASTM D 790 | yield, 3.2 mm, | MPa | 227 | 155 | 149 |
| Strength | | 1.27 mm/min | | | | |
| Tensile | ASTM D 638 | 5 mm/min | MPa | 9868 | 9913 | 10000 |
| Modulus | | | | | | |
| Tensile | ASTM D 638 | break, 5 mm/min | MPa | 147 | 113 | 109 |
| Strength | | | | | | |
| Tensile | ASTM D 638 | break, 5 mm/min | % | 2.2 | 1.6 | 1.6 |
| Elongation | | | | | | |
| Notched | ASTM D256 | 23° C., 2 lbf/ft | J/m | 98 | 38 | 36 |
| Izod | | | | | | |
| Unnotched | ASTM D256 | 23° C., 5 lbf/ft | J/m | 870 | 375 | 309 |
| Izod | | | | | | |
| Dielectric | | 1 GHz | | 3.493 | 3.525 | 3.560 |
| Constant | | | | | | |
| Dissipation | | 1 GHz | | 0.010 | 0.010 | 0.009 |
| Factor | | | | | | |
| Moisture | ISO 62 | 23° C., 24 hours | % | | | |
| Moisture | ISO 62 | 23° C., 312 hours | % | | | |
| Plating | | | | | | |
| Index | | | | | | |
| Drops | 0.2 mm, normal | | | 0 | | 0 |
| p(FTP) V0 | 0.2 mm, normal | | | 0.6 | | 1.0 |
| FOT 5 | 0.2 mm, normal | | second | 30 | | 18 |
| Drops | 0.4 mm, normal | | | 0 | | 0 |
| p(FTP) V0 | 0.4 mm, normal | | | 0.0 | | 1.0 |
| FOT 5 | 0.4 mm, normal | | second | 80 | | 29 |
| Drops | 0.8 mm, normal | | | 0 | | 0 |
| p(FTP) V0 | 0.8 mm, normal | | | 0.1 | | 1.0 |
| FOT 5 | 0.8 mm, normal | | second | 55 | | 30 |
| Drops | 1.2 mm, normal | | | 0 | | 0 |
| p(FTP) V0 | 1.2 mm, normal | | | 0.2 | | 1.0 |
| FOT 5 | 1.2 mm, normal | | second | 45 | | 33 |

While the invention has been described with reference to some embodiments, it will be understood by those skilled in the art that various changes may be made and equivalents may be substituted for elements thereof without departing from the scope of the invention. In addition, many modifications may be made to adapt a particular situation or material to the teachings of the invention without departing from essential scope thereof. Therefore, it is intended that the invention not be limited to the particular embodiments disclosed as the best mode contemplated for carrying out this invention, but that the invention will include all embodiments falling within the scope of the appended claims.

1. A composition comprising:
about 35% to about 75% by weight of at least one polyamide resin;
about 0.1% to about 20% by weight of a laser direct structuring additive, the laser activatable additive being operative to plate the composition upon being activated by a laser;
about 0.5% to 20% by weight of a phosphorus-containing additive that is a phosphazene, a bisphenol A bis(diphenyl phosphate) (BPADP) compound, an organopolyphosphate, a phosphinate salt, or a combination thereof; and
about 10% to 50% by weight of a reinforcing fiber;
wherein all weight percents are based on the total weight of the composition.

2. The composition of claim 1, comprising either:
(a) about 0.1% to less than 10% by weight of a phosphinate salt; or
(b) about 10% about 20% by weight of a phosphinate salt.

3. The composition of claim 1, wherein at least one polyamide resin comprises a 9,T polyamide resin, the 9,T polyamide resin being derived from a dicarboxybenzene (e.g., terephthalic acid) and a nonanediamine.

4. The composition of claim 1, wherein the laser direct structuring additive is a copper chromium oxide spinel, copper hydroxide phosphate, a copper phosphate, a copper sulfate, a cuprous thiocyanate, a spinel based metal oxide, a copper chromium oxide, an organic metal complex, a palladium/palladium-containing heavy metal complex, a metal oxide, a metal oxide-coated filler, antimony doped tin oxide coated on mica, a copper containing metal oxide, a zinc containing metal oxide, a tin containing metal oxide, a magnesium containing metal oxide, an aluminum containing metal oxide, a gold containing metal oxide, a silver containing metal oxide, or a combination thereof.

5. The composition of claim 1, wherein the laser direct structuring additive is present in a range of from about 1% to about 5% by weight relative to the total weight of the composition.

6. The composition of claim 1, wherein the phosphorus-containing additive is a phosphazene compound.

7. The composition of claim 1, wherein the phosphorus-containing additive is an organic phosphinate salt.

8. The composition of claim 1, wherein the reinforcing filler comprises glass fiber, wherein:
(a) at least a portion of the glass fiber comprises a flat glass fiber, provided that the total content of the flat glass fiber is less than 20% by weight of the total composition;
(b) at least a portion of the glass fiber comprises a glass fiber having a substantially circular cross-section, the substantially circular cross-section having a diameter of 10 microns or less or
(c) the glass fiber comprises a mixture of flat glass fibers and glass fibers having a substantially circular cross-section, the substantially circular cross-section having a diameter of 10 microns or less.

9. The composition of claim 1, further comprising an organic filler in an amount of 1 to 20 weight percent based on the total weight of the composition.

10. The composition of claim 1, further comprising an inorganic, mineral, or metallic filler in an amount of 1 to 4 weight percent based on the total weight of the composition, wherein:
(a) the inorganic, mineral, or metallic filler comprises aluminum flakes or needles in an amount in a range of from about 0.1 to 2 weight percent based on the total weight of the composition;
(b) the inorganic, mineral, or metallic filler is mica, talc, calcium carbonate, dolomite, wollastonite, barium sulfate, silica, kaolin, feldspar, or a combination comprising at least one of the foregoing mineral fillers; or
(c) 24. The composition of claim 21, wherein the inorganic, mineral, or metallic filler comprises talc having an average particle size of 1 to 3 micrometers.

11. The composition of claim 1, comprising:
about 35 to about 45% by weight of at least one polyamide resin;
about 2 to about 4% by weight of a laser direct structuring additive; the laser activatable comprising a copper oxide spinel or a copper chromium oxide spinel;
about 1% to 20% by weight of a phosphinate salt;
about 25% to 35% by weight of glass fibers, wherein glass fibers are present as a mixture of flat glass fibers and glass fibers having a substantially circular cross-section, the total content of the flat glass fiber being less than 18% of the total composition and the glass fibers having a substantially circular cross-section having a diameter of 8 microns or less; and
about 10-15% by weight of polyetherimide filler,
wherein all weight percents are based on the total weight of the composition.

12. The composition of claim 1 displaying:
(a) a flame out time (FOT) for a total of 5 bars of 40, seconds or less at a sample thickness of at least 0.2 millimeters when tested per a UL-94 protocol;
(b) a flexural modulus in a range of from 8500 to 9800 MPa when tested on a 32 mm sample, when tested at 1.27 mm/min as per ASTM D 790 at 23° C. (c) a tensile break strength in a range of from 110 to 150 MPa when tested at 5 mm/min as per ASTM D 638 at 23° C.;
(d) a tensile elongation in a range of from 1.5 to 2.5% when tested at 5 mm/min as per ASTM D 256 at 23° C.,
(e) an unnotched Izod strength in a range of from 300 to 600 J/m when tested at 5 5 lbf/ft as per ASTM D 256 at 23° C., or
(d) a combination of two or more of (a), (b), (c), (d), or (e).

13. A method comprising:
blending ingredients corresponding to the composition of claim 1; and
extruding the composition.

14. The method of claim 13, further comprising molding the composition.

15. The method of claim 12, further comprising laser direct structuring the molded composition.

16. The method of claim 15, further comprising plating the laser structured molded composition.

17. An article manufactured from the composition of claim 1, the composition having been optionally laser direct structured.

18. An article manufactured from the composition of claim 17, the composition having been laser direct structured and electrolessly plated.

19. The article of claim 18, wherein the composition is plated with copper.
